(19) United States
(12) Patent Application Publication
(10) Pub. No.: US 2021/0079546 A1
(43) Pub. Date: Mar. 18, 2021

(54) HYDROGEN SYSTEM AND METHOD OF OPERATING HYDROGEN SYSTEM

(71) Applicant: Panasonic Intellectual Property Management Co., Ltd., Osaka (JP)

(72) Inventors: HIDENOBU WAKITA, Kyoto (JP); TOMOYA KAMATA, Osaka (JP); OSAMU SAKAI, Osaka (JP); KUNIHIRO UKAI, Nara (JP); YUKIMUNE KANI, Osaka (JP); KEIICHI YAMAMOTO, Osaka (JP); MISA YOROZUYA, Osaka (JP)

(21) Appl. No.: 17/108,008

(22) Filed: Dec. 1, 2020

Related U.S. Application Data
(63) Continuation of application No. PCT/JP2020/009173, filed on Mar. 4, 2020.

(30) Foreign Application Priority Data
May 31, 2019 (JP) 2019-102589
Feb. 10, 2020 (JP) 2020-020407

(51) Int. Cl. C25B 15/08; C25B 1/10; C25B 9/08; C25B 13/08

(52) U.S. Cl. CPC C25B 15/08; C25B 13/08; C25B 9/08; C25B 1/10

(57) ABSTRACT

A hydrogen system includes: a compressor in which protons extracted from an anode fluid supplied to an anode move to a cathode through an electrolyte membrane and compressed hydrogen is generated; and a first eliminator including: a water-permeable membrane; a cathode gas flow path through which a cathode gas discharged from the cathode of the compressor flows, the cathode gas flow path being provided on one main surface of the water-permeable membrane; and an accommodation portion provided on the other main surface of the water-permeable membrane and filled with a liquid at a pressure lower than that of the cathode gas. The first eliminator removes moisture contained in the cathode gas.

### BACKGROUND

### 1. Technical Field

The present disclosure relates to a hydrogen system and a method of operating a hydrogen system.

### 2. Description of the Related Art

In recent years, due to environmental problems, such as global warming, and energy problems, such as exhaustion of oil resources, hydrogen is drawing attention as a clean alternative energy source to replace fossil fuels. When hydrogen burns, basically, water only is released, and carbon dioxide, which is a cause of global warming, is not discharged, and nitrogen oxides, etc. are hardly discharged. Accordingly, hydrogen is expected as clean energy. In addition, as an apparatus highly-efficiently utilizing hydrogen as a fuel, for example, fuel cells are known and are being developed and popularized as power sources for automobiles or private power generation for home use.

In the coming hydrogen society, in addition to the manufacturing of hydrogen, it is required to develop technology that can store hydrogen at high density and can transport or use hydrogen in a small volume and at low cost. In particular, in order to facilitate the popularization of fuel cells as a decentralized energy source, it is necessary to prepare a fuel supply infrastructure.

Accordingly, in order to stably supply hydrogen by a fuel supply infrastructure, various proposals for purifying high-purity hydrogen and increasing the pressure thereof have been made.

For example, Japanese Unexamined Patent Application Publication No. 2009-179842 discloses a water electrolysis apparatus that generates a high-pressure hydrogen gas while performing electrolysis of water. Here, the hydrogen gas generated by water electrolysis contains moisture. Accordingly, when such hydrogen is stored in a hydrogen storage unit, for example, in a tank, if the hydrogen contains a large amount of moisture, the amount of hydrogen in the hydrogen storage unit is decreased due to the presence of the moisture in the hydrogen storage unit, resulting in a reduction in efficiency. In addition, there is a problem of condensation of moisture contained in hydrogen in the hydrogen storage unit. Therefore, it is desired to decrease the amount of moisture in hydrogen when stored in a hydrogen storage unit to, for example, about 5 ppm or less. Accordingly, Japanese Unexamined Patent Application Publication No. 2009-179842 proposes a hydrogen-generating system including a gas-liquid separator for separating hydrogen and water and an adsorption column for adsorbing and removing moisture from hydrogen provided on the path, through which hydrogen flows, between the water electrolysis apparatus and the hydrogen storage unit.

In addition, for example, Japanese Unexamined Patent Application Publication (Translation of PCT Application) No. 2017-534435 proposes a system for stably removing moisture in hydrogen with an adsorption column for adsorbing and removing moisture in a high-pressure hydrogen gas configured as a pressure-swing adsorption (PSA) refining unit.

### SUMMARY

One non-limiting and exemplary embodiment provides a hydrogen system that can remove moisture contained in a cathode gas to be discharged from a cathode of a compressor more efficiently than before and a method of operating a hydrogen system.

In one general aspect, the techniques disclosed here feature a hydrogen system including: a compressor in which protons extracted from an anode fluid supplied to an anode move to a cathode through an electrolyte membrane and compressed hydrogen is generated; and a first eliminator including: a water-permeable membrane; a cathode gas flow path through which a cathode gas discharged from the cathode of the compressor flows, the cathode gas flow path being provided on one main surface of the water-permeable membrane; and an accommodation portion provided on the other main surface of the water-permeable membrane and filled with a liquid at a pressure lower than that of the cathode gas. The first eliminator removes moisture contained in the cathode gas.

The hydrogen system and a method of operating a hydrogen system according to an aspect of the present disclosure have an effect of capable of removing moisture contained in a cathode gas to be discharged from a cathode of a compressor more efficiently than before.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an example of a measurement apparatus for evaluating the water permeability of a water-permeable membrane;

FIG. 2A is a graph showing an example of the results of measurement of LLP of a water-permeable membrane;

FIG. 2B is a graph showing an example of the results of measurement of LVP of a water-permeable membrane;

FIG. 3 is a graph showing an example of the chemical potential of moisture in relation to relative humidity;

FIG. 4 is a diagram illustrating an example of the hydrogen system of a First Embodiment;

FIG. 5 is a diagram illustrating an example of the hydrogen system of a First Example of the First Embodiment;

FIG. 6 is a diagram illustrating an example of the hydrogen system of a Third Example of the First Embodiment;

FIG. 7 is a diagram illustrating an example of the hydrogen system of the Third Example of the First Embodiment;

FIG. 8 is a diagram illustrating an example of the hydrogen system of the Third Example of the First Embodiment;

FIG. 9 is a diagram illustrating an example of the hydrogen system of a Second Embodiment;

FIG. 10 is a diagram illustrating an example of the hydrogen system of an Example of the Second Embodiment;

FIG. 11 is a diagram illustrating an example of the hydrogen system of the Example of the Second Embodiment;

FIG. 12 is a diagram illustrating an example of the hydrogen system of a Third Embodiment;

FIG. 13 is a diagram illustrating an example of the hydrogen system of a Fourth Embodiment; and

FIG. 14 is a diagram illustrating an example of the hydrogen system of an Example of the Fourth Embodiment.

### DETAILED DESCRIPTION

In an electrochemical hydrogen pump using a solid polymer electrolyte membrane (hereinafter, electrolyte membrane) as an example of the above-described compressor, hydrogen (H₂) in an anode fluid such as a hydrogen-containing gas supplied to an anode is protonated and is moved to a cathode, and the pressure of hydrogen is increased by returning the protons (H⁺) to hydrogen (H₂) at the cathode. On this occasion, generally, the proton conductivity of the electrolyte membrane under a condition of a high temperature and a high humidity (for example, the temperature and the dew point of the hydrogen-containing gas to be supplied to the electrolyte membrane are about 60° C.) is increased, and the efficiency of the hydrogen compression operation of the electrochemical hydrogen pump is improved. Regarding this, the moisture amount in the cathode gas when a high-pressure hydrogen gas (hereinafter, cathode gas) to be discharged from the cathode of the electrochemical hydrogen pump is stored in a hydrogen storage unit is desired to be decreased to, for example, about 5 ppm or less as described above, but such efficient removal of moisture in a cathode gas is difficult in many cases.

For example, as the adsorption columns disclosed in Japanese Unexamined Patent Application Publication No. 2009-179842 and Japanese Unexamined Patent Application Publication (Translation of PCT Application) No. 2017-534435, the moisture in hydrogen can be adsorbed by a porous adsorbent such as zeolite. However, there is a limit to the moisture adsorbing performance of the adsorbent. Since the operating time of an adsorption column is determined based on the amount of water to be sent to the adsorption column, when an adsorption column is used under a condition that the moisture amount in hydrogen is large, it is necessary to increase the size of the adsorption column. In addition, since a high-pressure hydrogen gas flows through the adsorption column, the container of the adsorption column is needed to be configured to be capable of withstanding high pressure, resulting in a risk of further increasing the size of the adsorption column. Incidentally, as in Japanese Unexamined Patent Application Publication (Translation of PCT Application) No. 2017-534435, it is possible to decrease the filling amount of the adsorbent by using a pressure-swing adsorption refining unit. However, this case has problems such as complication of the member constituting the flow path through which hydrogen flows and necessity of handling hydrogen adsorbed to the adsorbent together with moisture when regenerating the adsorbent, and there is room for improvement.

Accordingly, the present inventors have diligently studied as follows and, as a result, have found that moisture in a cathode gas to be discharged from a cathode of an electrochemical hydrogen pump can be efficiently removed from the cathode gas by using a water-permeable membrane. Incidentally, Japanese Unexamined Patent Application Publication No. 2009-179842 proposes that moisture in a hydrogen gas to be discharged from a water electrolysis apparatus is separated from the hydrogen gas by a gas-liquid separator, but providing the above-described water-permeable membrane in the gas-liquid separator has not been investigated.

Accordingly, in the following measurement apparatus, a water-permeable membrane was incorporated in the apparatus, and the water permeability of the water-permeable membrane was evaluated.

### Measurement Apparatus

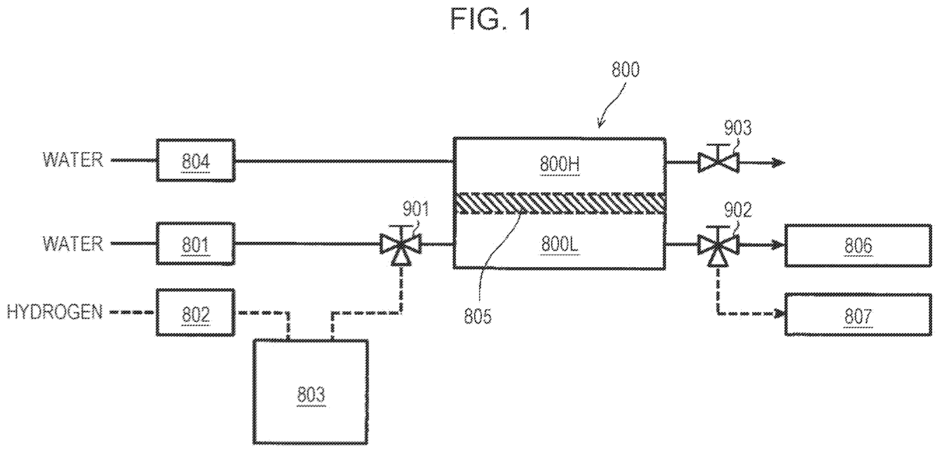

FIG. 1 is a diagram illustrating an example of a measurement apparatus for evaluating the water permeability of a water-permeable membrane.

The cell 800 of the measurement apparatus includes a storage portion 800L on a lower pressure side, a storage portion 800H on a higher pressure side, and a water-permeable membrane 805.

The storage portion 800L and the storage portion 800H each have a cylindrical shape, and in each thereof, a separator and a gas diffusion layer that are circular in a planar view are stacked. Incidentally, the separators are each made of a titanium metal, the gas diffusion layer of the storage portion 800L is made of a titanium powder sintered compact, and the gas diffusion layer of the storage portion 800H is made of a titanium fiber sintered compact.

The water-permeable membrane 805 is disposed between the respective gas diffusion layers of the storage portion 800L and the storage portion 800H, and a serpentine-shaped flow path (hereinafter, serpentine flow path) is formed in each of the main surface of the separators being in contact with these gas diffusion layers. Incidentally, these separators are arranged such that the inlet and outlet of the serpentine flow path of the storage portion 800L deviate by 90 degrees from the outlet and inlet of the serpentine flow path of the storage portion 800H. In addition, the water-permeable membrane 805 and the gas diffusion layers are sealed by O rings in grooves formed in the main surfaces of the separators.

In addition, in the measurement apparatus, Nafion (registered trademark, manufactured by DuPont de Nemours, Inc.) is used as the water-permeable membrane 805. Specifically, Nafion NRE-212 (product name, hereinafter, abbreviated as “N212 membrane”) having a thickness of 51 μm or Nafion 115 (product name, hereinafter, abbreviated as “N115 membrane”) having a thickness of 127 μm is used.

Incidentally, although the illustration is omitted, in the cell 800, an end plate is provided on the outer side of the separator of each of the storage portion 800L and the storage portion 800H, and the members of the cell 800 are fastened together with the end plates by a bolt passing through each of the members and a screw. In addition, a sheathed heater is embedded in each of the end plates. Consequently, the cell 800 can be heated up to an appropriate temperature.

The measurement apparatus is configured to be capable of measuring both the water permeability (liquid-vapor permeation; hereinafter, LVP) of the water-permeable membrane 805 from water (liquid) at a high pressure to a hydrogen-containing gas at a normal pressure and the water permeability (liquid-liquid permeation; hereinafter, LLP) of the water-permeable membrane 805 from water (liquid) at a high pressure to water (liquid) at a normal pressure.

Specifically, a manual hydraulic pump 804 that can apply a hydraulic pressure of about 2 MPaG to about 100 MPaG is connected to the inflow port (the inlet of the serpentine flow path) of the storage portion 800H of the cell 800. In addition, a two-way valve 903 is connected to the outflow port (the outlet of the serpentine flow path) of the storage portion 800H of the cell 800. Consequently, a desired hydraulic pressure can be applied to the water existing in the storage portion 800H of the cell 800.

Here, when the measurement of LLP of the water-permeable membrane 805 is started, three-way valves 901 and 902 connected to the inflow and outflow ports (the inlet and outlet of the serpentine flow path), respectively, of the storage portion 800L of the cell 800 are operated, and, as shown by the solid lines in FIG. 1, the inflow port (the inlet of the serpentine flow path) of the storage portion 800L communicates with a water pipe provided with a water pump 801, and the outflow port (the outlet of the serpentine flow path) of the storage portion 800L communicates with a water pipe provided with a scale 806.

In contrast, when the measurement of LVP of the water-permeable membrane 805 is started, the three-way valves 901 and 902 connected to the inflow and outflow ports (the inlet and outlet of the serpentine flow path), respectively, of the storage portion 800L of the cell 800 are operated, and, as shown by the dotted lines in FIG. 1, the inflow port (the inlet of the serpentine flow path) of the storage portion 800L communicates with a hydrogen pipe provided with a mass flow controller 802 and a bubbler 803, and the outflow port (the outlet of the serpentine flow path) of the storage portion 800L communicates with a hydrogen pipe provided with a mirror dew-point meter 807.

Incidentally, the measurement apparatus above is an example and is not limited to this example.

### Procedure and Result of Measurement of LLP of Water-Permeable Membrane 805

The procedure and results of measurement of LLP of the water-permeable membrane 805 will now be described.

First, the sheathed heater was controlled to adjust the temperature of the cell 800 to about 50° C.

Then, the hydraulic pump 804 was operated to fill the storage portion 800H of the cell 800 with water, and the two-way valve 903 was closed to seal the outflow port of the storage portion 800H. Simultaneously, the water pump 801 was operated to fill the storage portion 800L of the cell 800 with water, and the inflow port of the storage portion 800L was sealed by closing a sealing valve (not shown).

On this occasion, the operation of the hydraulic pump 804 was controlled such that the hydraulic pressure of water present in the storage portion 800H was about 2 MPaG. The amount of water flowing out from the outflow port of the storage portion 800L per fixed time was then measured with the scale 806 to derive the water permeation flux (permeation rate) of the water-permeable membrane 805.

Incidentally, the derivation of the water permeation flux of the water-permeable membrane 805 was performed also when the hydraulic pressure of water present in the storage portion 800H was about 5 MPaG, about 10 MPaG, about 15 MPaG, and about 20 MPaG.

In addition, the same measurement as above was performed when the temperature of the cell 800 was about 65° C. and about 70° C.

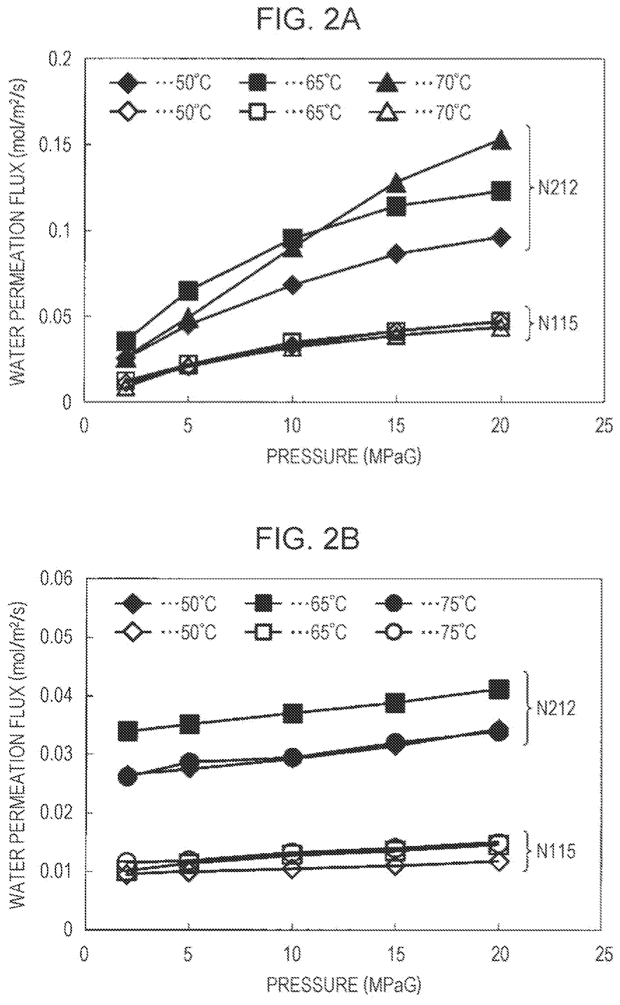

FIG. 2A is a graph showing an example of the results of measurement of LLP of a water-permeable membrane. The vertical axis of FIG. 2A represents the water permeation flux (mol/m²/s) of the water-permeable membrane 805, and the horizontal axis represents the hydraulic pressure (MPaG) of water present in the storage portion 800H.

FIG. 2A shows measurement data of LLP of the N212 membrane and the N115 membrane as the water-permeable membrane 805. Specifically, FIG. 2A plots the measured values (black lozenges and white lozenges) of LLP of the water-permeable membrane 805 when the temperature of the cell 800 was about 50° C., the measured values (black squares and white squares) of LLP of the water-permeable membrane 805 when the temperature of the cell 800 was about 65° C., and the measured values (black triangles and white triangles) of LLP of the water-permeable membrane 805 when the temperature of the cell 800 was about 70° C.

Incidentally, the procedure and results of the measurement above are examples and are not limited to this example.

### Procedure and Result of Measurement of LVP of Water-Permeable Membrane 805

The procedure and results of measurement of LVP of the water-permeable membrane 805 will now be described.

First, the sheathed heater was controlled to adjust the temperature of the cell 800 to about 50° C.

Then, the hydraulic pump 804 was operated to fill the storage portion 800H of the cell 800 with water, and the two-way valve 903 was closed to seal the outflow port of the storage portion 800H. Simultaneously, the mass flow controller 802 was operated to adjust the water temperature of the bubbler 803 such that the storage portion 800L of the cell 800 was filled with a hydrogen-containing gas having a relative humidity of about 38% on the basis of the cell temperature. The hydrogen-containing gas having a relative humidity of about 38% was then flown through the storage portion 800L at a desired flow rate (for example, about 500 to 1000 mL/min), and the dew point of the hydrogen-containing gas flowing out from the outflow port of the storage portion 800L was measured with the mirror dew-point meter 807.

Subsequently, the operation of the hydraulic pump 804 was controlled such that the hydraulic pressure of water present in the storage portion 800H was about 2 MPaG. The dew point of the hydrogen-containing gas flowing out from the outflow port of the storage portion 800L was then measured with the mirror dew-point meter 807 at the time when the measured value of the mirror dew-point meter 807 was stabilized to derive the water permeation flux (permeation rate) of the water-permeable membrane 805.

Incidentally, the derivation of the water permeation flux of the water-permeable membrane 805 was performed also when the hydraulic pressure of water present in the storage portion 800H was about 5 MPaG, about 10 MPaG, about 15 MPaG, and about 20 MPaG.

In addition, the same measurement as above was performed when the temperature of the cell 800 was about 65° C. and about 75° C.

FIG. 2B is a graph showing an example of the results of measurement of LVP of a water-permeable membrane. The vertical axis of FIG. 2B represents the water permeation flux (mol/m²/s) of the water-permeable membrane 805, and the horizontal axis represents the hydraulic pressure (MPaG) of water present in the storage portion 800H.

FIG. 2B shows measurement data of LVP of the N212 membrane and the N115 membrane as the water-permeable membrane 805. Specifically, FIG. 2B plots the measured values (black lozenges and white lozenges) of LVP of the water-permeable membrane 805 when the temperature of the cell 800 was about 50° C., the measured values (black squares and white squares) of LVP of the water-permeable membrane 805 when the temperature of the cell 800 was about 65° C., and the measured values (black circles and white circles) of LVP of the water-permeable membrane 805 when the temperature of the cell 800 was about 75° C.

Incidentally, the procedure and results of the measurement above are examples and are not limited to this example.

### Comparison

As understood from FIGS. 2A and 2B, at all temperatures of the cell 800, pressure dependence of LLP (permeation flux of water) of the water-permeable membrane 805 is higher than that of the LVP (permeation flux of water) of the water-permeable membrane 805. For example, when the water-permeable membrane 805 was the N212 membrane, this tendency significantly appeared, and the LLP (permeation flux of water) of the N212 membrane drastically increased with an increase in the hydraulic pressure of water present in the storage portion 800H and was about 2.7 to 5 times greater than the LVP (permeation flux of water) of the N212 membrane. For example, when the temperature of the cell 800 was about 70° C., the LLP (permeation flux of water) of the N212 membrane reached about 0.15 (mol/m²/s).

Incidentally, here, the permeability of water vapor of the water-permeable membrane 805 from a wet hydrogen-containing gas to a dry hydrogen-containing gas was not evaluated. However, in “M. Adachi et al., J. Electrochem. Soc., 156 (2009) B782; hereinafter, non-patent literature”, the water vapor permeability (vapor-vapor permeation: WP) of Nafion having a thickness of 56 μm is investigated, and, for example, 0.02 (mol/m²/s) is reported as the data of water vapor permeability (VVP) from a wet side of a relative humidity of 96% to a dry side of a relative humidity of 38% (chemical potential difference: 3.4 kJ/mol) at a temperature of 70° C.

The measurement data above of LLP and LVP of the water-permeable membrane 805 mean that when the hydraulic pressure of water present in the storage portion 800H is increased up to a predetermined pressure, the LLP of the water-permeable membrane 805 is higher than the LVP of the water-permeable membrane 805.

In addition, the above measurement data of the LLP and LVP of the water-permeable membrane 805 and the report in the above-mentioned non-patent literature mean that when the hydraulic pressure of water present in the storage portion 800H is increased up to a predetermined pressure, the LLP of the water-permeable membrane 805 is higher than the LVP and WP of the water-permeable membrane 805.

That is, a hydrogen system of a first aspect of the present disclosure was accomplished based on these findings and includes: a compressor in which protons extracted from an anode fluid supplied to an anode move to a cathode through an electrolyte membrane and compressed hydrogen is generated; and a first eliminator including: a water-permeable membrane; a cathode gas flow path through which a cathode gas discharged from the cathode of the compressor flows, the cathode gas flow path being provided on one main surface of the water-permeable membrane; and an accommodation portion provided on the other main surface of the water-permeable membrane and filled with a liquid at a pressure lower than that of the cathode gas. The first eliminator removes moisture contained in the cathode gas.

According to such a configuration, the hydrogen system of the present aspect can remove moisture contained in a cathode gas to be discharged from a cathode of a compressor more efficiently than before. Specifically, when the accommodation portion provided on the other main surface of the water-permeable membrane is filled with a liquid at a pressure lower than that of the cathode gas, the water permeation flux of the water-permeable membrane can be increased, compared to when the accommodation portion is filled with a low-pressure gas. The function and effect of such a hydrogen system of the present aspect are also verified from the measurement data of FIGS. 2A and 2B that when the hydraulic pressure of water is increased up to a predetermined pressure, the LLP of the water-permeable membrane is higher than the LVP of the water-permeable membrane.

Here, in a hydrogen system of a second aspect of the present disclosure, the first eliminator in the hydrogen system of the first aspect may include a discharge path for discharging the liquid to the accommodation portion.

In addition, in a hydrogen system of a third aspect of the present disclosure, the accommodation portion in the hydrogen system of the first or second aspect may be a flow path through which the liquid flows.

In a hydrogen system of a fourth aspect of the present disclosure, the temperature of the liquid may be lower than the temperature of the cathode gas flowing into the first eliminator in any one of the hydrogen systems of the first to third aspects. For example, the temperature of the liquid may be lower than the dew point of the cathode gas flowing into the first eliminator.

According to such a configuration, the hydrogen system of the present aspect can efficiently remove high-pressure condensed water condensed from a cathode gas to be discharged from a cathode of a compressor by using a water-permeable membrane.

Specifically, since the temperature of the liquid is lower than the temperature of a cathode gas flowing into the first eliminator, the cathode gas is cooled when the cathode gas passes through the first eliminator by heat exchange between the cathode gas and the liquid through a water-permeable membrane. Here, in the first eliminator, when the temperature of the liquid is lower than the dew point of the cathode gas flowing into the first eliminator, condensed water is easily generated from water vapor in the cathode gas. Accordingly, the high-pressure condensed water being in contact with the water-permeable membrane can efficiently permeate into the low-pressure liquid being in contact with the water-permeable membrane through the water-permeable membrane. For example, in water separation by a water-permeable membrane, when water vapor in a cathode gas is collected from the cathode gas as water vapor through the water-permeable membrane, it is inferred that, for example, the adsorption process of water vapor to the water-permeable membrane or the evaporation process of water passed through the water-permeable membrane could be a rate-limiting factor of the water permeability of the water-permeable membrane. In contrast, when high-pressure condensed water condensed from a cathode gas is collected from the cathode gas as water in a liquid state through a water-permeable membrane, it is inferred that since the above-mentioned processes are not performed, the water permeation flux of the water-permeable membrane can be increased compared to the former case, and as a result, moisture in the cathode gas can be efficiently removed in the first eliminator.

The function and effect of the hydrogen system of the present aspect as above are also verified from the measurement data of FIGS. 2A and 2B and the report in the non-patent literature that when the hydraulic pressure of water is increased up to a predetermined pressure, the LLP of the water-permeable membrane is higher than the LVP and VVP of the water-permeable membrane.

In a hydrogen system of a fifth aspect of the present disclosure, the liquid may include water in the hydrogen system according to any one of the first to fourth aspects.

According to such a configuration, the hydrogen system of the present aspect can simply and effectively remove moisture contained in the cathode gas to be discharged from the cathode of the compressor by using water, which has a large heat capacity and is readily available, as the liquid in the accommodation portion of the first eliminator.

However, the liquid in the accommodation portion of the first eliminator is not limited to such water. For example, it is possible to select a liquid having a high molecular weight not to pass through the pores of the water-permeable membrane and including a hydroxyl group forming a hydrogen bond. Incidentally, since the molecular weight of water is small, water passes through pores of various membranes. However, even if water is mixed with the cathode gas through the water-permeable membrane by that the magnitude relationship between the pressures in the cathode gas flow path (high pressure) and the liquid flow path (low pressure) of the first eliminator is reversed due to some cause, no adverse effect other than an increase in the amount of moisture in the cathode gas is caused.

A hydrogen system of a sixth aspect of the present disclosure may include a recycle flow path for supplying the liquid discharged from the first eliminator to the first eliminator again in the hydrogen system according to any one of the first to fifth aspects.

In the first eliminator, if hydrogen in the cathode gas passes through the water-permeable membrane, the liquid discharged from the first eliminator may contain hydrogen. In such a case, when the liquid discharged from the first eliminator is released to the outside, it is necessary to appropriately perform post treatment of hydrogen in the liquid. Accordingly, the hydrogen system of the present aspect can reduce such inconvenience by recycling the liquid discharged from the first eliminator through the recycle flow path.

In a hydrogen system of a seventh aspect of the present disclosure, in the hydrogen system according to any one of the first to fourth and sixth aspects, the liquid may contain water, the anode fluid may be a hydrogen-containing gas, and a supply path for supplying the liquid discharged from the first eliminator to the hydrogen-containing gas to be supplied to the anode may be provided.

In the first eliminator, the water discharged from the first eliminator may contain hydrogen by that hydrogen in the cathode gas passes through the water-permeable membrane. Accordingly, the hydrogen system of the present aspect can use such water to humidify the hydrogen-containing gas to be supplied to the anode of the compressor by supplying the water discharged from the first eliminator to the hydrogen-containing gas through the supply path. In addition, it is possible to move the hydrogen dissolved in water from the anode to the cathode of the compressor and to compress the hydrogen.

In a hydrogen system of an eighth aspect of the present disclosure, the water-permeable membrane may be a membrane of a polymer having a sulfonate group in the hydrogen system according to any one of the first to seventh aspects.

Since the sulfonate group of the polymer membrane can express hydrophilicity, a path of water can be formed in the polymer membrane. Accordingly, due to the configuration above, the hydrogen system of the present aspect can effectively show, in the first eliminator, a function of removing moisture contained in the cathode gas to be discharged from the cathode of the compressor.

A hydrogen system of a ninth aspect of the present disclosure need not energize the water-permeable membrane in the hydrogen system according to any one of the first to eighth aspects.

When the water-permeable membrane is a proton conductive electrolyte membrane, if electrodes including a material (e.g., platinum) that accelerates electrochemical hydrogen oxidation reaction and hydrogen generation reaction are provided on both sides of the water-permeable membrane and a current is passed between the electrodes on the water-permeable membrane, protons move in the water-permeable membrane according to the current, and, for example, there is a risk of causing electrolysis of a low-pressure liquid (e.g., water) in the water-permeable membrane. Accordingly, such a risk can be reduced by configurating the hydrogen system of the present aspect such that the water-permeable membrane is not energized.

In a hydrogen system of a tenth aspect of the present aspect, in the hydrogen system according to any one of the first to ninth aspects, a first porous structure may be provided in a flow path (hereinafter, liquid flow path) through which the liquid in the first eliminator flows. In addition, in a hydrogen system of an eleventh aspect of the present disclosure, in the hydrogen system according to any one of the first to tenth aspects, a second porous structure may be provided in the cathode gas flow path so as to be in contact with the water-permeable membrane.

If the first porous structure is not provided in the liquid flow path of the first eliminator, the water-permeable membrane is deformed such that the liquid flow path is occluded due to the differential pressure between the cathode gas flow path (high pressure) and the liquid flow path (low pressure) of the first eliminator. For example, such differential pressure has a risk of bringing the water-permeable membrane into contact with the member constituting the liquid flow path of the first eliminator. Consequently, the flow of the liquid in the liquid flow path may become difficult. However, in the hydrogen system of the present aspect, since the first porous structure is provided in the liquid flow path, such a problem is alleviated. Incidentally, the water passed through the water-permeable membrane can be efficiently discharged to the outside of the first eliminator together with the liquid in the liquid flow path through the pores of the first porous structure.

In addition, if the second porous structure is not provided in the cathode gas flow path of the first eliminator, the flow of the cathode gas in this cathode gas flow path tends to become a laminar flow. In such a case, since the moisture in the cathode gas flows together with the cathode gas, for example, moisture in the cathode gas present at a position away from the water-permeable membrane has a low probability of coming into contact with the water-permeable membrane. That is, in this case, there is a risk that the moisture passing through the water-permeable membrane is limited to the moisture in the cathode gas flowing near the main surface of the water-permeable membrane.

In contrast, the hydrogen system of this aspect can forcibly change the flow of the cathode gas in the cathode gas flow path in random directions by providing the second porous structure in the cathode gas flow path. In this case, there is a possibility that moisture in the cathode gas that present at various positions in the cathode gas flow path can come into contact with the water-permeable membrane. Consequently, in the hydrogen system of the present aspect, the probability that the moisture in the cathode gas and the water-permeable membrane come into contact with each other is higher than that when the second porous structure is not provided in the cathode gas flow path. Then, when the moisture in the cathode gas comes into contact with the water-permeable membrane, the high-pressure moisture coming into contact with the water-permeable membrane can efficiently permeate to the low-pressure liquid being in contact with the water-permeable membrane through the water-permeable membrane due to the differential pressure between the cathode gas flow path (high pressure) and the liquid flow path (low pressure) of the first eliminator. Consequently, it is possible to accelerate the removal of moisture contained in the cathode gas in the first eliminator.

In addition, if the second porous structure is provided not to be in contact with the water-permeable membrane, the cathode gas can easily pass through the gap between the second porous structure and the water-permeable membrane. Consequently, for example, when the size of the gap changes depending on the magnitude of the differential pressure between the cathode gas flow path (high pressure) and the liquid flow path (low pressure) of the first eliminator, the flow state of the cathode gas changes in the cathode gas flow path. Consequently, since the water permeability of the water-permeable membrane is affected, it is difficult to stably remove the moisture contained in the cathode gas. However, in the hydrogen system of the present aspect, the second porous structure is provided so as to be in contact with the water-permeable membrane, and thereby the contact interface between them can be stably kept to alleviate the problem above.

In addition, in the hydrogen system of the present aspect, the second porous structure is provided so as to be in contact with the water-permeable membrane and thereby functions as a thermal conductor for cooling the cathode gas flowing in the cathode gas flow path. Accordingly, the cathode gas is effectively cooled when the cathode gas passes through the cathode gas flow path. Consequently, the hydrogen system of the present aspect can accelerate the generation of condensed water from the water vapor in the cathode gas in the first eliminator, compared to when the second porous structure is provided not to be in contact with the water-permeable membrane.

In a hydrogen system of a twelfth aspect of the present disclosure, in the hydrogen system according to any one of the first to eleventh aspects, the compressor may be a stacked product that includes a cell including a cathode, an electrolyte membrane, and an anode, and the first eliminator and the stacked product may be integrally stacked.

According to such a configuration, in the hydrogen system of the present aspect, the system configuration can be simplified by stacking the compressor and the first eliminator. For example, a high-pressure cathode gas flows through the compressor and the first eliminator. Accordingly, if the compressor and the first eliminator are separately provided, high-rigid end plates for fixing the compressor and the first eliminator, respectively, are necessary in many cases.

Accordingly, in the hydrogen system of the present aspect, for example, since an end plate common to the compressor and the first eliminator can be used by integrally stacking the first eliminator and the above-described stacked product, the system configuration is simplified.

Incidentally, the water permeation of a water-permeable membrane, such as an electrolyte membrane, is caused by the difference between the chemical potentials of water on both sides of the water-permeable membrane. Here, the chemical potential of high-pressure water vapor has not been reported as far as the present inventors know. Accordingly, for example, the chemical potential (U_{liq_338}) of water at 65° C. and 20 MPaG was calculated from the known chemical potential (U⁰_{liq_338}) of water at 65° C. and a normal pressure and the following expression reported in “Job G. et. al., Eur. J. Phys., 27, 353 (2006)”, and the chemical potential of water vapor at 65° C. and 20 MPaG was computed from this chemical potential (U_{liq_338}) of water based on a known procedure.

U_{liq_338}=U⁰_{liq_338}+δ×[P(z)−P_{STD}]

In the expression, δ is “1.990 J mol⁻¹ atm⁻¹”, P(z) is the pressure applied to water, and P_{STD} is a normal pressure.

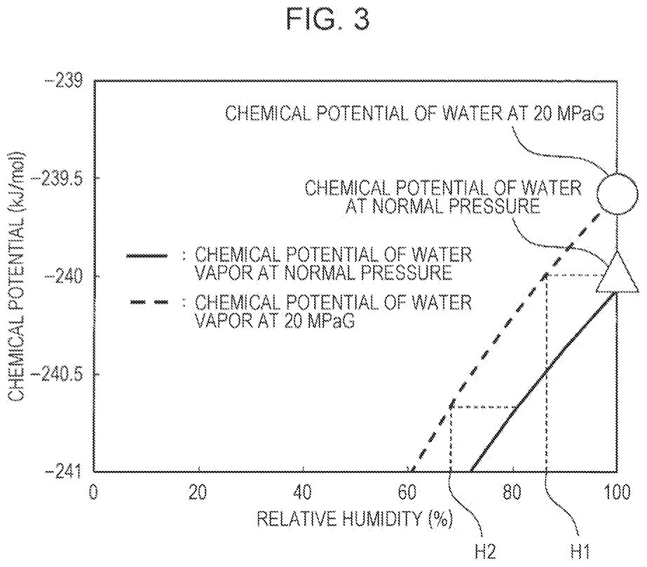

When the chemical potential of water vapor at 65° C. and 20 MPaG is compared to the chemical potential of water vapor at 65° C. and a normal pressure by taking the relative humidity (%) of water vapor on the horizontal axis, a chemical potential diagram (FIG. 3) thereof is obtained.

Water permeation of the water-permeable membrane is caused by the difference between the chemical potentials on both sides of the water-permeable membrane, as described above. Accordingly, even if a gas is supplied to a region on the low-pressure side of the water-permeable membrane with full humidification (relative humidity: 100%), the driving force for permeation of water works on the water-permeable membrane in the direction to decrease the relative humidity in a region on the high-pressure side of the water-permeable membrane until the chemical potentials on both sides of the water-permeable membrane become equal. For example, in the example shown in FIG. 3, a driving force for permeation of waterworks on the water-permeable membrane until the relative humidity in the region of 20 MPaG of the water-permeable membrane becomes H1.

Here, as understood from FIG. 3, when a gas with a relative humidity of less than 100% in the normal pressure region of the water-permeable membrane is supplied, the driving force for permeation of water works on the water-permeable membrane in the direction to decrease the relative humidity in the region of 20 MPaG of the water-permeable membrane to be lower than the H1. For example, when a gas with a relative humidity of 80% is supplied to the normal pressure region of the water-permeable membrane, the driving force for permeation of water works on the water-permeable membrane until the relative humidity in the region of 20 MPaG of the water-permeable membrane becomes H2 (H2<H1).

That is, a hydrogen system of a thirteenth aspect of the present disclosure was accomplished based on these findings, and the hydrogen system may include a second eliminator. The cathode gas passed through the first eliminate flows over one main surface of the water-permeable membrane in the second eliminator and a gas of which the chemical potential of water vapor contained in the gas is lower than that of the cathode gas flows over the other main surface of the water-permeable membrane in the second eliminator, in each of the hydrogen systems of the first to twelfth aspects.

In the accommodation portion of the first eliminator, since the low pressure side of the water-permeable membrane is filled with a liquid (e.g., water), as understood from the data on the chemical potential of a relative humidity of 100% shown in FIG. 3, there is a natural limit to the reduction of relative humidity of the cathode gas flowing over a region on the high-pressure side of the water-permeable membrane in the second eliminator. That is, it may be difficult to remove moisture in the cathode gas using only the first eliminator until the amount of moisture in the cathode gas is decreased to a desired low concentration.

Accordingly, in the hydrogen system of the present aspect, a gas of which the chemical potential of water vapor contained in the gas is lower than that of the cathode gas flows over the other main surface of the water-permeable membrane in the second eliminator. Consequently, the hydrogen system of the present aspect can decrease the amount of moisture in the cathode gas to a low concentration compared to the case of removing moisture in the cathode gas with only the first eliminator.

A hydrogen system of a fourteenth aspect of the present disclosure may include a third eliminator including an adsorbent for removing moisture in the cathode gas passed through the first eliminator, in each of the hydrogen systems of the first to twelfth aspects.

As describe above, it may be difficult to remove moisture in the cathode gas using only the first eliminator until the amount of moisture in the cathode gas is decreased to a desired low concentration.

Accordingly, the hydrogen system of the present aspect simply removes moisture in the cathode gas passed through the first eliminator using the adsorbent of the third eliminator by the above-described configuration.

In addition, in the hydrogen system of the present aspect, the adsorbent of the third eliminator may adsorb and remove only the moisture, that could not be removed by the first eliminator, contained in the cathode gas. Consequently, the hydrogen system of the present aspect can decrease the amount of moisture adsorbing to the adsorbent per unit time compared to the case of not removing moisture in the cathode gas by the first eliminator. Consequently, even if the filling amount of the adsorbent in the third eliminator is decreased, since the moisture adsorbing performance of the adsorbent of the third eliminator can be appropriately maintained for a desired period, it is possible to reduce the size and cost of the third eliminator.

A method of operating a hydrogen system of a fifteenth aspect of the present aspect includes a step of moving protons extracted from an anode fluid supplied to an anode to a cathode through an electrolyte membrane and generating compressed hydrogen and a step of moving moisture from a cathode gas containing the compressed hydrogen to a low-pressure liquid filling an accommodation portion through a water-permeable membrane.

Consequently, the method of operating a hydrogen system of the present aspect can remove moisture contained in the cathode gas to be discharged from the cathode of the compressor more efficiently than before. Incidentally, the details of the function and effect of the method of operating a hydrogen system of the present aspect are the same as the function and effect of the hydrogen system of the first aspect, and the description thereof is omitted.

Here, a method of operating a hydrogen system of a sixteenth aspect of the present disclosure may include a step of discharging the liquid in the accommodation portion in the method of operating a hydrogen system of the fifteenth aspect.

In addition, in a method of operating a hydrogen system of a seventeenth aspect of the present disclosure, the accommodation portion may be a flow path through which a liquid flows, in the method of operating a hydrogen system of the fifteenth aspect or the sixteenth aspect.

In a method of operating a hydrogen system of an eighteenth aspect of the present aspect, the temperature of the liquid may be lower than the temperature of the cathode gas, in the method of operating a hydrogen system according to any one of the fifteenth to seventeenth aspects.

Consequently, the method of operating a hydrogen system of the present aspect efficiently removes high-pressure condensed water condensed from the cathode gas to be discharged from the cathode of the compressor using the water-permeable membrane. Incidentally, the details of the function and effect of the method of operating a hydrogen system of the present aspect are the same as the function and effect of the hydrogen system of the fourth aspect, and the description thereof is omitted.

In a method of operating a hydrogen system of a nineteenth aspect of the present disclosure, the liquid may include water in the method of operating a hydrogen system according to any one of the fifteenth to eighteenth aspects.

Consequently, the method of operating a hydrogen system of the present aspect can simply and effectively remove moisture contained in the cathode gas to be discharged from the cathode of the compressor by using water, which has a large heat capacity and is readily available, as the liquid in the accommodation portion.

Examples of each aspect of the present disclosure will now be described with reference to the accompanying drawings.

The examples that will be described below are examples of each of the above-described aspects. Accordingly, the shapes, materials, components, arrangement positions and connection forms of the components, etc. shown below do not limit each of the above aspects unless otherwise specified in the claims. In addition, among the following components, a component that is not described in an independent claim showing the broadest concept of the present aspect will be described as an optional component. In addition, in drawings, the description may be omitted for the component indicated by the same reference sign. In addition, the drawings show each component schematically for easy understanding, and the shape, dimensional ratio, etc. may not be accurately expressed. In addition, in the operation method described below, for example, the order of the steps can be changed, as necessary. In addition, an additional known step may be performed, as necessary.

### First Embodiment

In the following embodiment, the configuration of a hydrogen system including an electrochemical hydrogen pump as an example of the above-described compressor and a method of operating a hydrogen system will be described.

### Apparatus Configuration

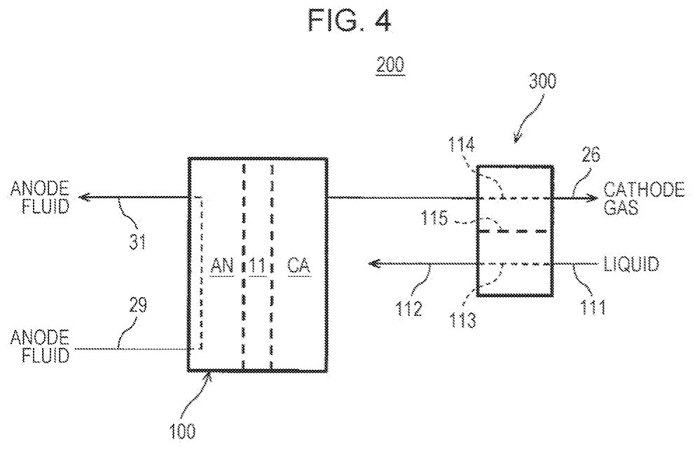

FIG. 4 is a diagram illustrating an example of the hydrogen system of a First Embodiment.

In the example shown in FIG. 4, the hydrogen system 200 includes an electrochemical hydrogen pump 100 and a first eliminator 300.

The electrochemical hydrogen pump 100 is a device for moving protons (H⁺) extracted from an anode fluid supplied to the anode AN to the cathode CA through the electrolyte membrane 11 and generating compressed hydrogen. Incidentally, as the anode fluid, for example, a hydrogen-containing gas or water can be used.

The configuration of the hydrogen system 200 when a hydrogen-containing gas is used as the anode fluid will now be described.

The electrochemical hydrogen pump 100 may have any configuration as long as it is an electrochemical compression device by the electrolyte membrane 11.

In the example shown in FIG. 4, in the electrochemical hydrogen pump 100, an anode gas introduction path 29 for supplying a hydrogen-containing gas to the anode AN, an anode gas extraction path 31 for discharging a hydrogen-containing gas from the anode AN, and a cathode gas extraction path 26 for discharging a cathode gas from the cathode CA are provided. Incidentally, the cathode gas is, for example, a high-pressure hydrogen-containing gas containing water vapor to be discharged from the cathode CA.

The first eliminator 300 includes a water-permeable membrane 115, a flow path (hereinafter, cathode gas flow path 114) provided on one main surface of the water-permeable membrane 115 and through which the cathode gas to be discharged from the cathode CA of the electrochemical hydrogen pump 100 flows, and an accommodation portion provided on the other main surface of the water-permeable membrane 115 and filled with a liquid at a pressure lower than that of the cathode gas, and the first eliminator 300 is a device for removing moisture contained in the cathode gas. Incidentally, the moisture in the cathode gas includes liquid water contained in the cathode gas. The moisture to be removed by the first eliminator 300 includes, for example, condensed water condensed from the cathode gas. This condensed water is generated in the flow path from the cathode CA of the electrochemical hydrogen pump 100 to the first eliminator 300 of the cathode gas extraction path 26 or in the cathode gas flow path 114 in the first eliminator 300.

The first eliminator 300 may have any configuration as long as it is a membrane-type eliminating device that can remove moisture contained in a cathode gas.

For example, as shown in FIG. 4, the first eliminator 300 may include a cathode gas flow path 114, a flow path 113 (hereinafter, liquid flow path 113) through which a low-pressure liquid flows, and a water-permeable membrane 115 provided between these flow paths 113 and 114. That is, in this case, the liquid flow path 113 corresponds to the accommodation portion. Another example of the accommodation portion will be described in a Fourth Embodiment.

Incidentally, the first eliminator 300 includes: a cathode gas extraction path 26 through which a cathode gas to the cathode gas flows to path 114; and a liquid introduction path 111 and a liquid extraction path 112 through which the liquid flows to path 113.

The water-permeable membrane 115 may have any configuration as long as it is a membrane that has low permeability for hydrogen (H2) in a cathode gas and permeates moisture in the cathode gas.

For example, the water-permeable membrane 115 may be made of a membrane of a polymer having a sulfonate group. Consequently, it is possible to impart a function of permeating not only water in a liquid state in a cathode gas but also water vapor to the water-permeable membrane 115. Incidentally, since the sulfonate group of the polymer membrane can express hydrophilicity, a path of water can be formed in the polymer membrane. Accordingly, in the hydrogen system 200 of the present embodiment, due to the configuration above, the first eliminator 300 can effectively show the function of removing moisture contained in the cathode gas to be discharged from the cathode of the electrochemical hydrogen pump 100.

Here, in the hydrogen system 200 of the present embodiment, the temperature of the liquid flowing into the first eliminator 300 is lower than the temperature of the cathode gas flowing into the first eliminator 300. For example, the temperature of the liquid flowing into the first eliminator 300 is lower than the dew point of the cathode gas flowing into the first eliminator 300. Accordingly, in the hydrogen system 200 of the present embodiment, a cooler (not shown) may be provide at an appropriate position of the liquid introduction path 111.

Incidentally, an example of the hydrogen system 200 in which the electrochemical hydrogen pump 100 and the first eliminator 300 are integrally configured will be described in a Third Example.

### Operation

An example of operation of the hydrogen system 200 of the First Embodiment will now be described with reference to the drawings.

Incidentally, the following operation may be performed by, for example, reading out a control program from a memory circuit of a controller (not shown) by an arithmetic circuit of the controller. However, it is not indispensable to perform the following operation by a controller. An operator may perform a part of the operation. In addition, the operation of the hydrogen system 200 when a hydrogen-containing gas is used as the anode fluid will be described below.

First, a hydrogen-containing gas of a low pressure is supplied to the anode AN of the electrochemical hydrogen pump 100, and also the voltage of a voltage application device (not shown in FIG. 4) is applied to the electrochemical hydrogen pump 100. Consequently, in the electrochemical hydrogen pump 100, protons extracted from the hydrogen-containing gas that is supplied to the anode AN move to the cathode CA through the electrolyte membrane 11, and a step of generating compressed hydrogen (hydrogen compression operation) is performed. Specifically, in the anode catalyst layer of the anode AN, a hydrogen molecule is separated into hydrogen ions (protons) and electrons by an oxidation reaction (expression (1)). The protons are conducted in the electrolyte membrane 11 and move to a cathode catalyst layer. The electrons move to the cathode catalyst layer through the voltage application device. Accordingly, in the cathode catalyst layer, a hydrogen molecular is generated again by a reduction reaction (expression (2)). Incidentally, it is known that when protons are conducted in the electrolyte membrane 11, a predetermined amount of water move along with the protons from the anode AN to the cathode CA as electroosmotic water.

Anode: H₂ (low pressure)→2H⁺+2e⁻ (1)

Cathode: 2H⁺+2e⁻→H² (high pressure) (2)

Hydrogen generated at the cathode CA of the electrochemical hydrogen pump 100 is compressed at the cathode CA as a cathode gas containing water vapor. For example, the cathode gas can be compressed at the cathode CA by increasing the pressure drop of the cathode gas extraction path 26 by using a flow rate regulator (not shown). Incidentally, as the flow rate regulator, for example, a back pressure valve and a regulating valve provided in the cathode gas extraction path 26 can be exemplified.

Subsequently, the pressure drop of the flow rate regulator is decreased to discharge the cathode gas from the cathode CA of the electrochemical hydrogen pump 100 to the outside of the electrochemical hydrogen pump 100 through the cathode gas extraction path 26.

Then, in the first eliminator 300, a step of moving moisture from the cathode gas containing compressed hydrogen to a low-pressure liquid filling the liquid flow path 113 through the water-permeable membrane 115 is performed. Specifically, in the first eliminator 300, the cathode gas to be discharged from the cathode CA of the electrochemical hydrogen pump 100 flows to one main surface of the water-permeable membrane 115. Accordingly, in the first eliminator 300, the operation of removing moisture contained in the cathode gas is performed by flowing a liquid at a pressure lower than that of the cathode gas to the other main surface of the water-permeable membrane 115. On this occasion, the moisture includes liquid water contained in the cathode gas. This moisture includes, for example, condensed water condensed from the cathode gas. This condensed water is generated in the flow path from the cathode CA of the electrochemical hydrogen pump 100 to the first eliminator 300 of the cathode gas extraction path 26 or in the cathode gas flow path 114 in the first eliminator 300. In addition, the temperature of the liquid flowing into the first eliminator 300 may be lower than the temperature of the cathode gas flowing into the first eliminator 300.

From the above, the hydrogen system 200 and the method of operating the hydrogen system 200 of the present embodiment can remove moisture contained in the cathode gas to be discharged from the cathode CA of the electrochemical hydrogen pump 100 more efficiently than before. Specifically, the water permeation flux of the water-permeable membrane 115 can be increased by flowing a low-pressure liquid to the other main surface of the water-permeable membrane 115, compared to the case of flowing a low-pressure gas to this main surface. Such function and effect of the hydrogen system 200 and the method of operating the hydrogen system 200 of the present embodiment are also verified from the measurement data of FIGS. 2A and 2B that when the hydraulic pressure of water is increased up to a predetermined pressure, the LLP of the water-permeable membrane is high compared to the LVP of the water-permeable membrane.

For example, the hydrogen system 200 and the method of operating the hydrogen system 200 of the present embodiment efficiently removes high-pressure condensed water condensed from the cathode gas to be discharged from the cathode CA of the electrochemical hydrogen pump 100 by using the water-permeable membrane 115.

Specifically, since the temperature of the liquid flowing into the first eliminator 300 is lower than the temperature of the cathode gas flowing into the first eliminator 300, the cathode gas is cooled when the cathode gas passes through the first eliminator 300 by heat exchange between the cathode gas and the liquid through the water-permeable membrane 115. Here, in the first eliminator 300, when the temperature of the liquid flowing into the first eliminator 300 is lower than the dew point of the cathode gas flowing into the first eliminator 300, condensed water is readily generated from the water vapor in the cathode gas. Consequently, the high-pressure condensed water being in contact with the water-permeable membrane 115 can efficiently permeate to the low-pressure liquid being in contact with the water-permeable membrane 115 through the water-permeable membrane 115. For example, in the water separation by the water-permeable membrane 115, when the water vapor in the cathode gas is collected from the cathode gas as water vapor through the water-permeable membrane 115, it is inferred that, for example, the adsorption process of water vapor to the water-permeable membrane 115 or the evaporation process of water passed through the water-permeable membrane 115 could be a rate-limiting factor of the water permeability of the water-permeable membrane 115. In contrast, when high-pressure condensed water condensed from a cathode gas is collected from the hydrogen-containing gas as water in a liquid state through the water-permeable membrane 115, it is inferred that since the above-mentioned processes are not performed, the water permeation flux of the water-permeable membrane 115 can be increased compared to the former case, and as a result, moisture in the cathode gas can be efficiently removed in the first eliminator 300.

The function and effect of the hydrogen system 200 and the method of operating the hydrogen system 200 of the present embodiment as above are also verified from the measurement data of FIGS. 2A and 2B and the report in the non-patent literature that when the hydraulic pressure of water is increased up to a predetermined pressure, the LLP of the water-permeable membrane is higher than the LVP and WP of the water-permeable membrane.

Incidentally, although illustration is omitted here, members and equipment necessary for the hydrogen compression operation of the hydrogen system 200 of the present embodiment are appropriately provided.

For example, in the hydrogen system 200, for example, a temperature sensor for detecting the temperature of the electrochemical hydrogen pump 100 and a pressure sensor for detecting the pressure of the cathode gas compressed at the cathode CA of the electrochemical hydrogen pump 100 may be provided. In addition, in the hydrogen system 200, for example, valves may be disposed at appropriate positions of the anode gas introduction path 29, the anode gas extraction path 31, the cathode gas extraction path 26, the liquid introduction path 111, and the liquid extraction path 112 for opening and closing these paths.

The configuration of the hydrogen system 200 above is an example and is not limited to this example. For example, in the electrochemical hydrogen pump 100, a dead end structure in which the anode gas extraction path 31 is not provided and the whole quantity of hydrogen (H₂) in the hydrogen-containing gas that is supplied to the anode AN through the anode gas introduction path 29 is compressed at the cathode CA may be employed.

In addition, the hydrogen-containing gas may be, for example, a pure hydrogen gas or a gas having a hydrogen concentration lower than that of a pure hydrogen gas. The latter hydrogen-containing gas may be, for example, a hydrogen gas generated by electrolysis of water or a modified gas containing hydrogen.

### First Example

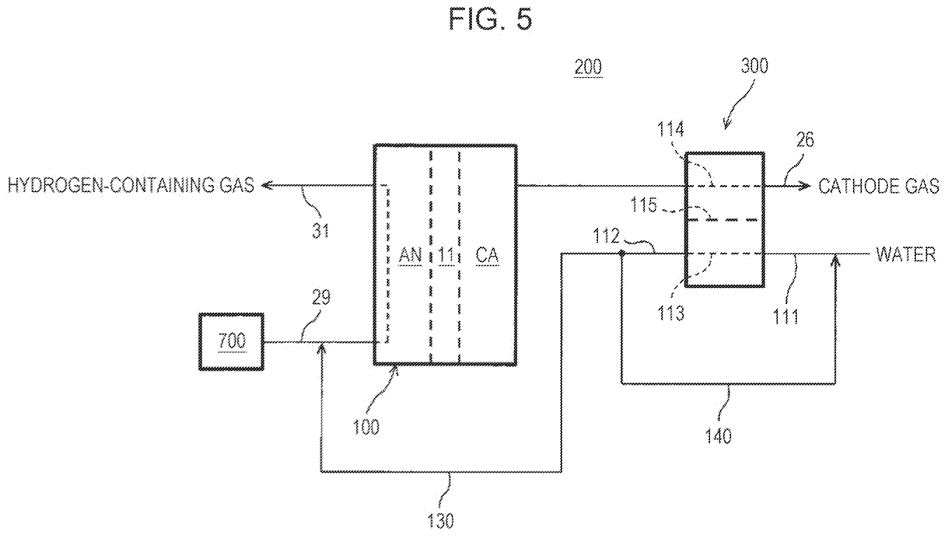

FIG. 5 is a diagram illustrating an example of the hydrogen system of a First Example of the First Embodiment.

In the example shown in FIG. 5, the hydrogen system 200 includes an electrochemical hydrogen pump 100, a first eliminator 300, a recycle flow path 140, a supply path 130, and a hydrogen source 700.

Here, the electrochemical hydrogen pump 100 and the first eliminator 300 are the same as those in the hydrogen system 200 of the First Embodiment, and the description thereof is omitted.

In the hydrogen system 200 and the method of operating the hydrogen system 200 of the present example, the liquid flows through the first eliminator 300 includes water. Consequently, the hydrogen system 200 and the method of operating the hydrogen system 200 of the present example can simply and effectively remove moisture contained in the cathode gas to be discharged from the cathode CA of the electrochemical hydrogen pump 100 by using water, which has a large heat capacity and is readily available, as the liquid flowing through the first eliminator 300.

However, the liquid flowing through the first eliminator 300 is not limited to such water. For example, it is possible to select a liquid that does not pass through the pores of the water-permeable membrane 115 due to its high molecular weight and has a hydroxyl group forming a hydrogen bond. Incidentally, since the molecular weight of water is small, water passes through pores of various membranes. However, even if water is mixed with the cathode gas through the water-permeable membrane 115 by that the magnitude relationship between the pressures in the cathode gas flow path 114 (high pressure) and the liquid flow path 113 (low pressure) of the first eliminator 300 is reversed due to some cause, no adverse effect other than an increase in the amount of moisture in the cathode gas is caused.

In addition, in the hydrogen system 200 and the method of operating the hydrogen system 200 of the present example, the anode fluid supplied to the anode AN of the electrochemical hydrogen pump 100 is the hydrogen-containing gas from the hydrogen source 700. Incidentally, examples of the hydrogen-containing gas that is generated in the hydrogen source 700 include a modified gas that occurs by modification reaction of methane gas or the like and a hydrogen gas that occurs by electrolysis of water.

Here, the recycle flow path 140 is a flow path for supplying the water discharged from the first eliminator 300 to the first eliminator 300 again. The supply path 130 is a flow path for supplying the water discharged from the first eliminator 300 to the hydrogen-containing gas that is supplied to the anode AN of the electrochemical hydrogen pump 100. That is, in the present example, the liquid extraction path 112 branches into the recycle flow path 140 and the supply path 130 at a branching portion, and the downstream end of the recycle flow path 140 is connected to the liquid introduction path 111, and the downstream end of the supply path 130 is connected to the anode gas introduction path 29.

Incidentally, in the hydrogen system 200 of FIG. 5, a flow rate controller (not shown) for controlling the flow rate of water flowing in the recycle flow path 140 and the supply path 130 may be provided. The flow rate controller may have any configuration as long as the flow rate of such water can be controlled. Examples of the flow rate controller include a flow rate control valve. The flow rate control valve may be, for example, a three-way valve capable of controlling the flow dividing ratio or a three-way switching valve, provided at the junction (the above-mentioned branching portion) of the recycle flow path 140 and the supply path 130. In addition, the flow rate control valve may be a two-way valve capable of controlling the degree of its opening or an on-off valve, provided on one of or both the supply path 130 and the recycle flow path 140. Furthermore, in the hydrogen system 200 of FIG. 5, a cooler (not shown) for cooling the water flowing in the recycle flow path 140 may be provided. The cooler may have any configuration as long as it has a cooling function for cooling the water. The cooler may be, for example, a cooler of an air cooling type or a cooler using a cooling liquid. The former cooler includes, for example, a cooling fan or a cooling fin. The latter cooler includes, for example, a flow path member through which a cooling liquid flows. As the cooling liquid, for example, cooling water or antifreeze liquid can be used.

The functions and effects of the hydrogen system 200 and the method of operating the hydrogen system 200 of the present example will now be described.

In the first eliminator 300, when hydrogen in the cathode gas passes through the water-permeable membrane 115, the water discharged from the first eliminator 300 may contain hydrogen. In such a case, it is necessary to appropriately perform post treatment of the hydrogen dissolved in water when the water discharged from the first eliminator 300 is discharged to the outside.

Accordingly, the hydrogen system 200 and the method of operating the hydrogen system 200 of the present example can reduce such inconvenience by recycling the water discharged from the first eliminator 300 through the recycle flow path 140.

In addition, the hydrogen system 200 and the method of operating the hydrogen system 200 of the present example can use such water for humidifying the hydrogen-containing gas to be supplied to the anode AN of the electrochemical hydrogen pump 100 by supplying the water discharged from the first eliminator 300 to the hydrogen-containing gas through the supply path 130. In addition, it is possible to move hydrogen dissolved in water from the anode AN to the cathode CA of the electrochemical hydrogen pump 100 and compress the hydrogen.

Except for the above features, the hydrogen system 200 and the method of operating the hydrogen system 200 of the present example may be the same as those in the First Embodiment.

### Second Example

The hydrogen system 200 of this Example is same as the hydrogen system 200 of the First Embodiment except that a first porous structure is provided in the liquid flow path 113 in the first eliminator 300 and that a second porous structure is provided in the cathode gas flow path 114 in the first eliminator 300 so as to be in contact with the water-permeable membrane 115. Incidentally, the first porous structure may be provided in the liquid flow path 113 in the first eliminator 300 so as to be in contact with the water-permeable membrane 115 of the first eliminator 300.

The first porous structure desirably has high rigidity that can suppress the displacement and deformation of the water-permeable membrane 115 occurring due to a differential pressure between the cathode gas flow path 114 (high pressure) and the liquid flow path 113 (low pressure) of the first eliminator 300. For example, the first porous structure may be made of a metal. The second porous structure made of a metal may be, for example, a metal sintered compact. Examples of the metal sintered compact include a metal sintered compact of stainless steel or titanium and a metal fiber sintered compact.

The second porous structure desirably has elasticity so as to appropriately follow the displacement and deformation of the water-permeable membrane 115 occurring due to a differential pressure between the cathode gas flow path 114 (high pressure) and the liquid flow path 113 (low pressure) of the first eliminator 300. For example, the second porous structure may be made of an elastic body including carbon fibers. Examples of the elastic body include a carbon felt composed of stacked carbon fibers.

The function and effect of the hydrogen system 200 of the present example when the first porous structure is provided in the liquid flow path 113 of the first eliminator 300 so as to be in contact with the water-permeable membrane 115 will now be described.

If the first porous structure is not provided in the liquid flow path 113 of the first eliminator 300, the water-permeable membrane 115 is deformed in the direction to occlude the liquid flow path 113 by the differential pressure between the cathode gas flow path 114 (high pressure) and the liquid flow path 113 (low pressure) of the first eliminator 300. For example, such differential pressure has a risk of bringing the water-permeable membrane 115 into contact with the member constituting the liquid flow path 113 of the first eliminator 300. Consequently, the flow of the liquid in the liquid flow path 113 may become difficult. However, in the hydrogen system 200 of the present example, since the first porous structure is provided in the liquid flow path 113, such problems are alleviated. Incidentally, the water passed through the water-permeable membrane 115 can be efficiently discharged to the outside of the first eliminator 300 together with the liquid in the liquid flow path 113 through the pores of the first porous structure.

In addition, if the first porous structure is provided not to be in contact with the water-permeable membrane 115, for example, bending stress on the water-permeable membrane 115 based on the differential pressure between the cathode gas flow path 114 (high pressure) and the liquid flow path 113 (low pressure) of the first eliminator 300 may occur at the edge portion of the member constituting the liquid flow path 113 of the first eliminator 300. Consequently, although the water-permeable membrane 115 may be damaged by such bending force, in the hydrogen system 200 of the present example, since the first porous structure is provided so as to be in contact with the water-permeable membrane 115, such problems are alleviated.

In addition, if the first porous structure is provided not to be in contact with the water-permeable membrane 115, for example, a liquid can easily pass through the gap between the second porous structure and the water-permeable membrane 115.

Consequently, for example, when the size of the gap changes depending on the magnitude of the differential pressure between the cathode gas flow path 114 (high pressure) and the liquid flow path 113 (low pressure), the flow state of the liquid changes in the liquid flow path 113. Consequently, since the water permeability of the water-permeable membrane 115 is affected, it is difficult to stably remove the moisture contained in the cathode gas. However, in the hydrogen system 200 of the present example, the first porous structure is provided so as to be in contact with the water-permeable membrane 115, and thereby the contact interface between them can be stably kept to alleviate the problem above.

Next, the function and effect of the hydrogen system 200 of the present example when the second porous structure is provided in the cathode gas flow path 114 of the first eliminator 300 so as to be in contact with the water-permeable membrane 115 will be described.

If the second porous structure is not provided in the cathode gas flow path 114 of the first eliminator 300, the flow of the cathode gas in the cathode gas flow path 114 tends to become a laminar flow. In such a case, since the moisture in the cathode gas flows together with the cathode gas, for example, moisture in the cathode gas present at a position away from the water-permeable membrane 115 has a low probability of coming into contact with the water-permeable membrane 115. That is, in this case, there is a risk that the moisture passing through the water-permeable membrane 115 is limited to the moisture in the cathode gas flowing near the main surface of the water-permeable membrane 115.

In contrast, the hydrogen system 200 of the present example can forcibly change the flow of the cathode gas in the cathode gas flow path 114 in random directions by providing a second porous structure in the cathode gas flow path 114. In this case, there is a possibility that moisture in the cathode gas, the moisture being present at various positions in the cathode gas flow path 114, can come into contact with the water-permeable membrane 115. Consequently, in the hydrogen system 200 of the present example, the probability that the moisture in the cathode gas and the water-permeable membrane 115 come into contact with each other is higher than that when the second porous structure is not provided in the cathode gas flow path 114. Then, when the moisture in the cathode gas comes into contact with the water-permeable membrane 115, the high-pressure moisture coming into contact with the water-permeable membrane 115 can efficiently permeate to the low-pressure liquid being in contact with the water-permeable membrane 115 through the water-permeable membrane 115 due to the differential pressure between the cathode gas flow path 114 (high pressure) and the liquid flow path 113 (low pressure) of the first eliminator 300. Consequently, it is possible to accelerate the removal of moisture contained in the cathode gas in the first eliminator 300.

In addition, if the second porous structure is provided not to be in contact with the water-permeable membrane 115, the cathode gas can easily pass through the gap between the second porous structure and the water-permeable membrane. Consequently, for example, when the size of the gap changes depending on the magnitude of the differential pressure between the cathode gas flow path 114 (high pressure) and the liquid flow path 113 (low pressure) of the first eliminator 300, the flow state of the cathode gas changes in the cathode gas flow path 114. Consequently, since the water permeability of the water-permeable membrane 115 is affected, it is difficult to stably remove the moisture contained in the cathode gas. However, in the hydrogen system 200 of the present example, the second porous structure is provided so as to be in contact with the water-permeable membrane 115, and thereby the contact interface between them can be stably kept to alleviate the problem above.

In addition, in the hydrogen system 200 of the present example, the second porous structure is provided so as to be in contact with the water-permeable membrane 115 and thereby functions as a thermal conductor for cooling the cathode gas flowing in the cathode gas flow path 114. Accordingly, the cathode gas is effectively cooled when it passes through the cathode gas flow path 114. Consequently, the hydrogen system 200 of the present example can accelerate the generation of condensed water from the water vapor in the cathode gas in the first eliminator 300 compared to when the second porous structure is provided not to be in contact with the water-permeable membrane 115.

Next, the function and effect of the hydrogen system 200 of the present example when the first porous structure and the second porous structure are made of a metal material and an elastic material, respectively, will be described.

The hydrogen system 200 of the present example can appropriately secure the rigidity of the first porous structure by making the first porous structure with a metal material. Consequently, the water-permeable membrane 115 is hardly deformed by the differential pressure between the cathode gas flow path 114 (high pressure) and the liquid flow path 113 (low pressure). Therefore, it is possible to stably keep the contact interface between the first porous structure and the water-permeable membrane 115 and the contact interface between the second porous structure and the water-permeable membrane 115. Consequently, the hydrogen system 200 of the present example can stabilize the removal of moisture contained in the cathode gas.

The hydrogen system 200 of the present example can appropriately cause elastic deformation of the second porous structure by making the second porous structure with an elastic material. Consequently, even if a differential pressure between the cathode gas flow path 114 (high pressure) and the liquid flow path 113 (low pressure) of the first eliminator 300 occurs, the contact interface between the second porous structure and the water-permeable membrane 115 can be stably kept.

For example, when the water-permeable membrane 115 is deformed by occurrence of the differential pressure in the direction to occlude the liquid flow path 113 or when the member (hereinafter, flow path member) constituting the cathode gas flow path 114 is deformed to the outside, it is difficult to stably keep the contact interface between the second porous structure and the water-permeable membrane 115. Consequently, as described above, since the water permeability of the water-permeable membrane 115 is affected, it is difficult to stably remove the moisture contained in the cathode gas. However, in the hydrogen system 200 of the present example, the second porous structure is made of an elastic material, and thereby the elastic deformation of the second porous structure can follow the deformation of the water-permeable membrane 115 and the deformation of the flow path member in the direction to maintain the contact between the second porous structure and the water-permeable membrane 115. For example, in a configuration in which the second porous structure is accommodated in a recess of the flow path member, it is preferred to previously compress the second porous structure by an amount not less than the amount corresponding to the deformation amount of both the water-permeable membrane 115 and the flow path member and then accommodate the second porous structure in the recess of the flow path member.

Except for the above features, the hydrogen system 200 of the present example may be the same as the hydrogen system 200 of the First Embodiment or the First Example of the First Embodiment.

### Third Example

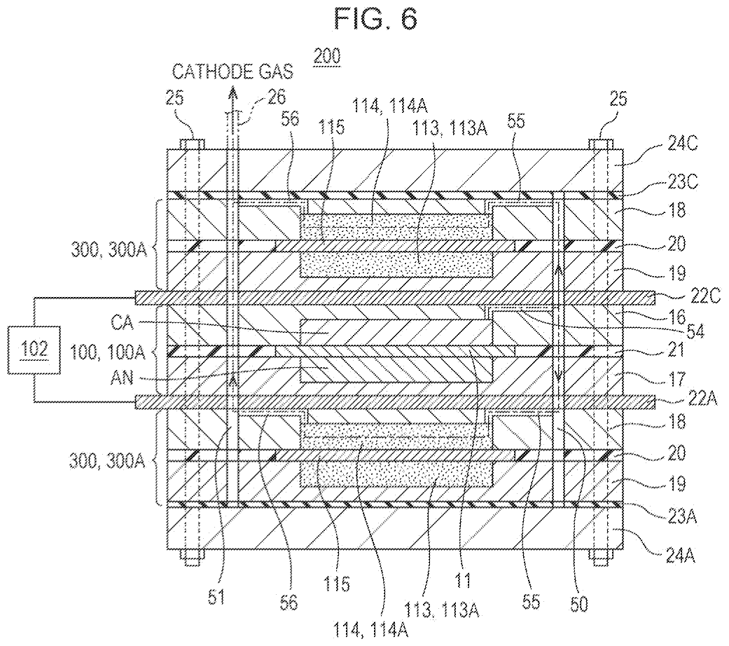

FIGS. 6, 7, and 8 are diagrams illustrating an example of the hydrogen system of a Third Example of the First Embodiment. In the hydrogen system 200 of this example, an electrochemical hydrogen pump 100 and first eliminators 300 are integrally configured.

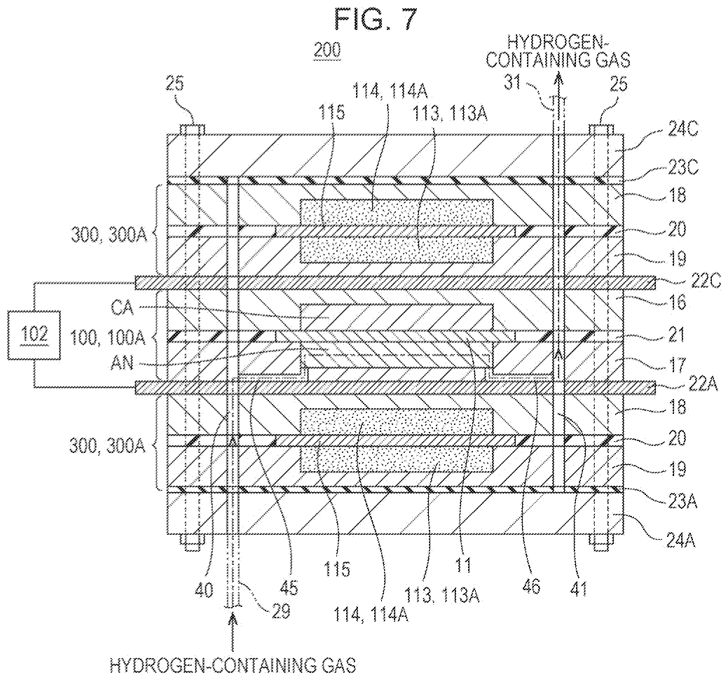

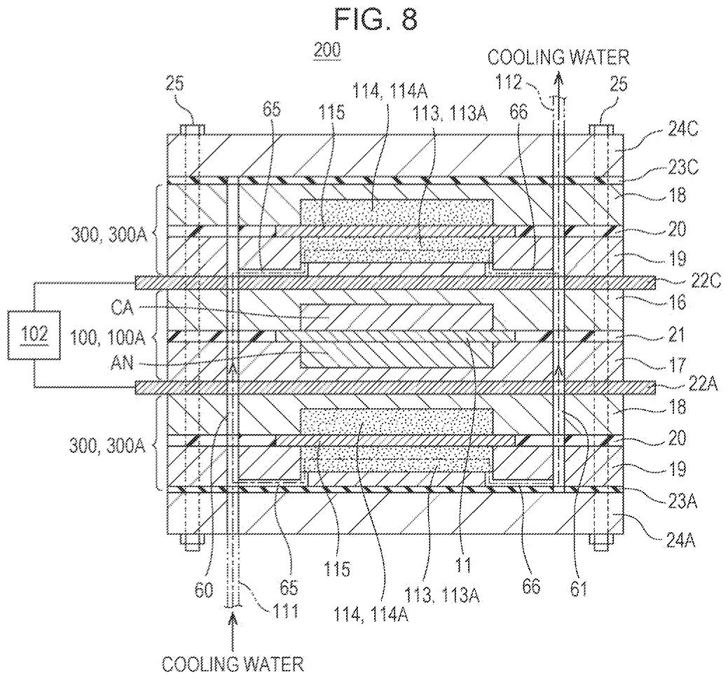

Incidentally, FIG. 6 shows a vertical cross section including a straight line passing through the center of the hydrogen system 200, the center of a cathode gas pass-through manifold 50, and the center of a cathode gas extraction manifold 51 in a planar view. FIG. 7 shows a vertical cross section including a straight line passing through the center of the hydrogen system 200, the center of an anode gas introduction manifold 40, and the center of an anode gas extraction manifold 41 in a planar view. FIG. 8 shows a vertical cross section including a straight line passing through the center of the hydrogen system 200, the center of a liquid introduction manifold 60, and the center of a liquid extraction manifold 61 in a planar view.

### Configuration of Electrochemical Hydrogen Pump

An example of the configuration of the electrochemical hydrogen pump 100 will now be described with reference to the drawings.

As shown in FIGS. 6, 7, and 8, the hydrogen system 200 includes at least one hydrogen pump unit 100A of the electrochemical hydrogen pump 100.

Incidentally, in the electrochemical hydrogen pump 100, a plurality of hydrogen pump units 100A may be stacked. That is, although the example shown by FIGS. 6, 7, and 8 includes one hydrogen pump unit 100A, the number of the hydrogen pump unit 100A is not limited to this example. The number of the hydrogen pump unit 100A can be appropriately set based on, for example, the operating conditions such as the amount of hydrogen to be compressed at the cathode CA of the electrochemical hydrogen pump 100.

The hydrogen pump unit 100A includes an electrolyte membrane 11, an anode AN, a cathode CA, a cathode separator 16, an anode separator 17, and an insulator 21. Incidentally, in the hydrogen pump unit 100A, a catalyst coated membrane CCM in which an anode catalyst layer and a cathode catalyst layer are integrally connected to an electrolyte membrane 11 is often used.

The anode AN is provided on one main surface of the electrolyte membrane 11. The anode AN is an electrode including an anode catalyst layer and an anode gas diffusion layer. Here, when the catalyst coated membrane CCM is used as the electrolyte membrane 11, the anode gas diffusion layer is provided on the main surface of the anode catalyst layer connected to the catalyst coated membrane CCM. Incidentally, an annular sealing member (not shown) is provided so as to surround the circumference of the anode catalyst layer, and the anode catalyst layer is appropriately sealed by such a sealing member.

The cathode CA is provided on the other main surface of the electrolyte membrane 11. The cathode CA is an electrode including a cathode catalyst layer and a cathode gas diffusion layer. Here, when the catalyst coated membrane CCM is used as the electrolyte membrane 11, the cathode gas diffusion layer is provided on the main surface of the cathode catalyst layer connected to the catalyst coated membrane CCM. Incidentally, an annular sealing member is provided so as to surround the circumference of the cathode catalyst layer, and the cathode catalyst layer is appropriately sealed by such a sealing member.

From the above, in the hydrogen pump unit 100A, the electrolyte membrane 11 is sandwiched by the anode AN and the cathode CA such that the anode catalyst layer and the cathode catalyst layer are in contact with the electrolyte membrane 11. Incidentally, a cell including a cathode CA, an electrolyte membrane 11, and an anode AN is referred to as a membrane-electrode assembly (hereinafter, MEA), and the electrochemical hydrogen pump 100 may be a stacked product including at least one cell including a cathode CA, an electrolyte membrane 11, and an anode AN.

The electrolyte membrane 11 has proton conductivity. The electrolyte membrane 11 may have any configuration as long as it has proton conductivity. Examples of the electrolyte membrane 11 include, but not limited to, a fluorine-based polymer electrolyte membrane and a hydrocarbon-based polymer electrolyte membrane. Specifically, for example, Nafion (registered trademark, manufactured by DuPont de Nemours, Inc.) or Aciplex (registered trademark, manufactured by Asahi Kasei Corporation) can be used as the electrolyte membrane 11.

The anode catalyst layer is provided on one main surface of the electrolyte membrane 11. The anode catalyst layer includes, for example, platinum as a catalytic metal, but the catalytic metal is not limited thereto.

The cathode catalyst layer is provided on the other main surface of the electrolyte membrane 11. The cathode catalyst layer includes, for example, platinum as a catalytic metal, but the catalytic metal is not limited thereto.

Examples of catalyst supports of the cathode catalyst layer and the anode catalyst layer include, but not limited to, carbon powder, such as carbon black and graphite, and conductive oxide powder.

Incidentally, in the cathode catalyst layer and the anode catalyst layer, catalytic metal microparticles are supported on a catalyst support in a highly dispersed state. In addition, a hydrogen ion conductive ionomer component is usually added to these cathode catalyst layer and anode catalyst layer in order to increase the electrode reaction field.

The cathode gas diffusion layer is provided on the cathode catalyst layer. In addition, the cathode gas diffusion layer is made of a porous material and has electronic conductivity and gas diffusivity. Furthermore, the cathode gas diffusion layer desirably has elasticity so as to appropriately follow the displacement and deformation of the constructional member occurring due to a differential pressure between the cathode CA and the anode AN during the operation of the electrochemical hydrogen pump 100. Incidentally, in the electrochemical hydrogen pump 100 of the present example, a member constituted of carbon fibers is used as the cathode gas diffusion layer. For example, a porous carbon fiber sheet, such as carbon paper, carbon cloth, or carbon felt, may be used. Incidentally, a carbon fiber sheet need not be used as a base material of the cathode gas diffusion layer. For example, as a base material of the cathode gas diffusion layer, a metal fiber sintered compact of a material such as titanium, a titanium alloy, or stainless steel or a metal powder sintered compact of such a material may be used.

The anode gas diffusion layer is provided on the anode catalyst layer. In addition, the anode gas diffusion layer is made of a porous material and has electronic conductivity and gas diffusivity. Furthermore, the anode gas diffusion layer desirably has high rigidity that can suppress the displacement and deformation of the constructional member occurring due to a differential pressure between the cathode CA and the anode AN during the operation of the electrochemical hydrogen pump 100.

Incidentally, in the electrochemical hydrogen pump 100 of the present example, a member constituted of a thin plate of a titanium powder sintered compact is used as the anode gas diffusion layer, but the anode gas diffusion layer is not limited thereto. That is, as the base material of the anode gas diffusion layer, for example, a metal fiber sintered compact of a material such as titanium, a titanium alloy, or stainless steel or a metal powder sintered compact of such a material can be used. In addition, as the base material of the anode gas diffusion layer, for example, an expanded metal, metal mesh, or a punching metal can also be used.

The anode separator 17 is a member provided on the anode gas diffusion layer of the anode AN. The cathode separator 16 is a member provided on the cathode gas diffusion layer of the cathode CA.

The cathode separator 16 and the anode separator 17 are each provided with a recess at the respective center. The cathode gas diffusion layer and the anode gas diffusion layer are respectively accommodated in these recesses.

The MEA is thus sandwiched by the cathode separator 16 and the anode separator 17 to form the hydrogen pump unit 100A.

Incidentally, a serpentine-shaped anode gas flow path (not shown) including, for example, a plurality of turning U-shaped portions and a plurality of straight portions in a planar view is provided in the main surface of the anode separator 17 being in contact with the anode gas diffusion layer. However, such an anode gas flow path is an example, and the anode gas flow path is not limited thereto. For example, the anode gas flow path may be composed of a plurality of straight flow paths.

In addition, an annular and tabular insulator 21 that is provided so as to surround the circumference of the MEA in a planar view is sandwiched between the conductive cathode separator 16 and anode separator 17. Consequently, the cathode separator 16 and the anode separator 17 are prevented from short-circuiting.

Here, as shown in FIGS. 6, 7, and 8, the hydrogen system 200 includes an anode feed plate 22A provided to the anode separator 17 of the hydrogen pump unit 100A, a cathode feed plate 22C provided to the cathode separator 16 of the hydrogen pump unit 100A, and a voltage application device 102.

The voltage application device 102 is a device for applying a voltage between the anode catalyst layer and the cathode catalyst layer. Specifically, a high potential of the voltage application device 102 is applied to the anode catalyst layer, and a low potential of the voltage application device 102 is applied to the cathode catalyst layer. The voltage application device 102 may have any configuration as long as a voltage can be applied between the anode catalyst layer and the cathode catalyst layer. For example, the voltage application device 102 may be a device for controlling the voltage to be applied between the anode catalyst layer and the cathode catalyst layer. Specifically, the voltage application device 102 includes a DC/DC convertor when it is connected to a DC power supply, such as a battery, a solar cell, or a fuel cell, and includes an AC/DC convertor when it is connected to an AC power supply, such as a commercial power supply.

In addition, the voltage application device 102 may be, for example, a power-type power supply for adjusting the voltage to be applied between the anode catalyst layer and the cathode catalyst layer and the current flowing between the anode catalyst layer and the cathode catalyst layer such that the power to be supplied to the hydrogen pump unit 100A is a predetermined set level.

In the example shown in FIGS. 6, 7, and 8, the terminal of the voltage application device 102 on the low potential side is connected to the cathode feed plate 22C, and the terminal of the voltage application device 102 on the high potential side is connected to the anode feed plate 22A. In this example, the cathode feed plate 22C is in an electrical contact with the cathode separator 16, and the anode feed plate 22A is in an electrical contact with the anode separator 17. Incidentally, although illustration is omitted, when multiple cells each including a cathode CA, an electrolyte membrane 11, and an anode AN are stacked in the electrochemical hydrogen pump 100, the anode feed plate 22A is in an electrical contact with the anode separator 17 located at one end in the stacking direction of these members, and the cathode feed plate 22C is in an electrical contact with the cathode separator 16 located at the other end in the stacking direction of these members.

### Configuration of First Eliminator

An example of the configuration of the first eliminator 300 will now be described with reference to the drawings.

As shown in FIGS. 6, 7, and 8, the hydrogen system 200 includes first removal units 300A of a pair of upper and lower first eliminators 300 provided so as to place the hydrogen pump unit 100A therebetween through the anode feed plate 22A and the cathode feed plate 22C, respectively.

Incidentally, in the example shown in FIGS. 6, 7, and 8, although one first removal unit 300A is shown in each of the first eliminators 300, the number of the first removal unit 300A is not limited to this example. In addition, the first removal units 300A provided in the pair of upper and lower first eliminators 300 have the same configuration.

The first removal unit 300A includes a water-permeable membrane 115, a first porous structure 113A, a second porous structure 114A, a separator 18, a separator 19, and an insulator 20.

The water-permeable membrane 115 may have any configuration as long as it is a membrane that has low permeability for hydrogen (H₂) in a cathode gas and permeates moisture in the cathode gas, as described above. Incidentally, as such a water-permeable membrane 115, for example, a proton conductive polymer membrane made of a material similar to that of the electrolyte membrane 11 and allowing protons (H⁺) to pass therethrough can be used. That is, examples of the water-permeable membrane 115 include, but not limited to, a fluorine-based polymer membrane and a hydrocarbon-based polymer membrane that can be used as a proton conductive polymer membrane.

The first porous structure 113A is provided in the liquid flow path 113 so as to be in contact with the water-permeable membrane 115. The first porous structure 113A desirably has high rigidity that can suppress the displacement and deformation of the water-permeable membrane 115 occurring due to a differential pressure between the cathode gas flow path 114 (high pressure) and the liquid flow path 113 (low pressure) of the first eliminator 300. Incidentally, the base material of such a first porous structure 113A may be, for example, the same metal material as that of the anode gas diffusion layer.

The second porous structure 114A is provided in the cathode gas flow path 114 so as to be in contact with the water-permeable membrane 115. The second porous structure 114A desirably has elasticity so as to appropriately follow the displacement and deformation of the water-permeable membrane 115 occurring due to a differential pressure between the cathode gas flow path 114 (high pressure) and the liquid flow path 113 (low pressure) of the first eliminator 300. Incidentally, the base material of such a second porous structure 114A may be, for example, the same metal material as that of the cathode gas diffusion layer.

The separator 18 is a member provided on the second porous structure 114A. The separator 19 is a member provided on the first porous structure 113A.

The separator 18 and the separator 19 are each provided with a recess at the respective center. The second porous structure 114A and the first porous structure 113A are respectively accommodated in these recesses. Incidentally, in the present example, the regions partitioned by the respective recesses of the separator 18 and the separator 19 and the water-permeable membrane 115 constitute the cathode gas flow path 114 and the liquid flow path 113, respectively, of the first eliminator 300.

In addition, an annular and tabular insulator 20 that is provided so as to surround the circumference of the MEA in a planar view is sandwiched between the separator 18 and the separator 19.

The first removal unit 300A may thus have a cell structure as in the hydrogen pump unit 100A.

### Fastening Configuration of Electrochemical Hydrogen Pump and First Eliminator

An example of the configuration of fastening the electrochemical hydrogen pump 100 and the first eliminator 300 will now be described with reference to the drawings.

As shown in FIGS. 6, 7, and 8, the hydrogen system 200 includes an anode insulating plate 23A and an anode end plate 24A, a cathode insulating plate 23C and a cathode end plate 24C, and a fastening device 25.

Here, the anode insulating plate 23A and the anode end plate 24A are provided in this order at one end in the stacking direction of the hydrogen pump unit 100A and the first removal unit 300A. The cathode insulating plate 23C and the cathode end plate 24C are provided in this order at the other end in the stacking direction.

The fastening device 25 is a member for fastening each member of the hydrogen pump unit 100A, each member of the first removal unit 300A, an anode feed plate 22A, an anode insulating plate 23A, an anode end plate 24A, a cathode feed plate 22C, a cathode insulating plate 23C, and a cathode end plate 24C in the stacking direction. The fastening device 25 may have any configuration as long as these members can be thus fastened in the stacking direction.

Examples of the fastening device 25 include a bolt and a nut with disc spring.

On this occasion, although the bolt as the fastening device 25 may be configured so as to pass through only the anode end plate 24A and the cathode end plate 24C, in the hydrogen system 200 of the present example, the bolt passes through each member of the hydrogen pump unit 100A and the first removal unit 300A, the anode feed plate 22A, the anode insulating plate 23A, the anode end plate 24A, the cathode feed plate 22C, the cathode insulating plate 23C, and the cathode end plate 24C. A desired fastening pressure is then applied to the hydrogen pump unit 100A and the first removal units 300A with the fastening device 25 by placing the end face of the separator 19 located at one end in the stacking direction and the end face of the separator 18 located at the other end in the stacking direction between the anode end plate 24A and the cathode end plate 24C through the anode insulating plate 23A and the cathode insulating plate 23C, respectively.

From the above, in the electrochemical hydrogen pump 100 of the present example, the hydrogen pump unit 100A and the first removal units 300A are appropriately held in a stacked state by the fastening pressure of the fastening device 25 in the stacking direction, and the bolt of the fastening device 25 passes through each member of the electrochemical hydrogen pump 100 and the first removal units 300A. Consequently, it is possible to appropriately prevent each of these members from moving in the in-plane direction.

### Flow Path Configuration for Cathode Gas

An example of the configuration of the flow path for a cathode gas in the electrochemical hydrogen pump 100 and the first eliminator 300 will now be described with reference to FIG. 6. Incidentally, in FIG. 6, a schematic diagram of the flow of a cathode gas is shown by an arrow of a thin dash-dot-dash line.

As shown in FIG. 6, the hydrogen system 200 includes a cathode gas pass-through manifold 50 and a cathode gas extraction manifold 51.

The cathode gas pass-through manifold 50 is composed of a series of communication holes provided at appropriate positions of each member of the hydrogen pump unit 100A and the first removal unit 300A, the anode feed plate 22A, and the cathode feed plate 22C. Accordingly, the cathode gas pass-through manifold 50 communicates with the cathode gas diffusion layer of the cathode CA through the first cathode gas pass-through path 54 provided in the cathode separator 16 and also communicates with the cathode gas flow path 114 through the second cathode gas pass-through path 55 provided in the separator 18.

The cathode gas extraction manifold 51 is composed of a series of communication holes provided at appropriate positions of each member of the hydrogen pump unit 100A and the first removal unit 300A, the anode feed plate 22A, the cathode feed plate 22C, the cathode insulating plate 23C, and the cathode end plate 24C. That is, the cathode gas extraction path 26 (see FIG. 4) is connected to the communication hole of the cathode end plate 24C. Consequently, the cathode gas extraction path 26 and the cathode gas extraction manifold 51 are communicated with each other. The cathode gas extraction path 26 may be configured of a pipe through which the cathode gas flows. The cathode gas extraction manifold 51 then communicates with the cathode gas flow path 114 through the third cathode gas pass-through path 56 provided in the separator 18.

Due to the configuration above, the high-pressure cathode gas compressed at the cathode CA of the electrochemical hydrogen pump 100 flows through the first cathode gas pass-through path 54, the cathode gas pass-through manifold 50, the second cathode gas pass-through path 55, the cathode gas flow path 114, the third cathode gas pass-through path 56, and the cathode gas extraction manifold 51 in this order as shown by the arrow of a dash-dot-dash line in FIG. 6. Subsequently, the cathode gas is discharged to the outside of the hydrogen system 200 through the cathode gas extraction path 26. On this occasion, when the cathode gas passes through the cathode gas flow path 114 of the first removal unit 300A, the moisture contained in the cathode gas is removed in the first removal unit 300A.

Incidentally, annular sealing members (not shown) are provided at appropriate positions between members in a planar view so as to surround the cathode gas pass-through manifold 50 and the cathode gas extraction manifold 51, and the cathode gas pass-through manifold 50 and the cathode gas extraction manifold 51 are appropriately sealed by the sealing members.

### Flow Path Configuration for Hydrogen-Containing Gas

An example of the configuration of the flow path for a hydrogen-containing gas when the anode fluid supplied to the anode AN of the hydrogen pump unit 100A is a hydrogen-containing gas will now be described with reference to FIG. 7. Incidentally, in FIG. 7, a schematic diagram of the flow of a hydrogen-containing gas is shown by an arrow of a thin dash-dot-dash line.

As shown in FIG. 7, the hydrogen system 200 includes an anode gas introduction manifold 40 and an anode gas extraction manifold 41.

The anode gas introduction manifold 40 is composed of a series of communication holes provided at appropriate positions of each member of the hydrogen pump unit 100A and the first removal unit 300A, the anode feed plate 22A, the cathode feed plate 22C, the anode insulating plate 23A, and the anode end plate 24A. An anode gas introduction path 29 (see FIG. 4) is connected to the communication hole of the anode end plate 24A. Consequently, the anode gas introduction path 29 and the anode gas introduction manifold 40 are communicated with each other. The anode gas introduction path 29 may be configured of a pipe through which the hydrogen-containing gas to be supplied to the anode AN flows. The anode gas introduction manifold 40 then communicates with the anode gas diffusion layer of the anode AN through a first anode gas pass-through path 45 provided in the anode separator 17. For example, the first anode gas pass-through path 45 may be connected to one end of the serpentine-shaped anode gas flow path (not shown) provided in the anode separator 17.

The anode gas extraction manifold 41 is composed of a series of communication holes provided at appropriate positions of each member of the hydrogen pump unit 100A and the first removal unit 300A, the anode feed plate 22A, the cathode feed plate 22C, the cathode insulating plate 23C, and the cathode end plate 24C. An anode gas extraction path 31 (see FIG. 4) is connected to the communication hole of the cathode end plate 24C. Consequently, the anode gas extraction path 31 and the anode gas extraction manifold 41 are communicated with each other. The anode gas extraction path 31 may be configured of a pipe through which the hydrogen-containing gas to be discharged from the anode AN flows. The anode gas extraction manifold 41 then communicates with the anode gas diffusion layer of the anode AN through a second anode gas pass-through path 46 provided in the anode separator 17. For example, the second anode gas pass-through path 46 may be connected to the other end of the serpentine-shaped anode gas flow path (not shown) provided in the anode separator 17.

Due to the configuration above, the hydrogen-containing gas from the anode gas introduction path 29 flows through the anode gas introduction manifold 40, the first anode gas pass-through path 45, the anode AN, the second anode gas pass-through path 46, and the anode gas extraction manifold 41 in this order as shown by the arrow of a dash-dot-dash line in FIG. 7. Subsequently, the hydrogen-containing gas is discharged to the outside of the hydrogen pump unit 100A through the anode gas extraction path 31. On this occasion, when the hydrogen-containing gas passes through the anode AN of the hydrogen pump unit 100A, part of the hydrogen-containing gas is supplied to the electrolyte membrane 11, and the hydrogen in the hydrogen-containing gas is compressed in the hydrogen pump unit 100A.

Incidentally, annular sealing members (not shown) are provided at appropriate positions between members in a planar view so as to surround the anode gas introduction manifold 40 and the anode gas extraction manifold 41, and the anode gas introduction manifold 40 and the anode gas extraction manifold 41 are appropriately sealed by the sealing members.

### Flow Path Configuration for Cooling Water

An example of the configuration of the flow path for cooling water when the liquid that is supplied to the liquid flow path 113 of the first removal unit 300A is cooling water will now be described with reference to FIG. 8. Incidentally, in FIG. 8, a schematic diagram of the flow of cooling water is shown by an arrow of a thin dash-dot-dash line.

As shown in FIG. 8, the hydrogen system 200 includes a liquid introduction manifold 60 and a liquid extraction manifold 61.

The liquid introduction manifold 60 is composed of a series of communication holes provided at appropriate positions of each member of the hydrogen pump unit 100A and the first removal unit 300A, the anode feed plate 22A, the cathode feed plate 22C, the anode insulating plate 23A, and the anode end plate 24A. A liquid introduction path 111 (see FIG. 4) is connected to the communication hole of the anode end plate 24A. Consequently, the liquid introduction path 111 and the liquid introduction manifold 60 are communicated with each other. The liquid introduction path 111 may be configured of a pipe through which the cooling water to be supplied to the liquid flow path 113 flows. The liquid introduction manifold 60 then communicates with the liquid flow path 113 through a first liquid pass-through path 65 provided in the separator 19.

The liquid extraction manifold 61 is composed of a series of communication holes provided at appropriate positions of each member of the hydrogen pump unit 100A and the first removal unit 300A, the anode feed plate 22A, the cathode feed plate 22C, the cathode insulating plate 23C, and the cathode end plate 24C. A liquid extraction path 112 (see FIG. 4) is connected to the communication hole of the cathode end plate 24C. Consequently, the liquid extraction path 112 and the liquid extraction manifold 61 are communicated with each other. The liquid extraction path 112 may be configured of a pipe through which the cooling water to be discharged from the liquid flow path 113 flows. The liquid extraction manifold 61 then communicates with the liquid flow path 113 through a second liquid pass-through path 66 provided in the separator 19.

Due to the configuration above, the cooling water from the liquid introduction path 111 flows through the liquid introduction manifold 60, the first liquid pass-through path 65, the liquid flow path 113, the second liquid pass-through path 66, and the liquid extraction manifold 61 in this order as shown by the arrow of a dash-dot-dash line in FIG. 8. Subsequently, the cooling water is discharged to the outside of the first removal unit 300A through the liquid extraction path 112.

Incidentally, an annular sealing members (not shown) are provided at appropriate positions between members in a planar view so as to surround the liquid introduction manifold 60 and the liquid extraction manifold 61, and the liquid introduction manifold 60 and the liquid extraction manifold 61 are appropriately sealed by the sealing members.

Incidentally, the above integrated configuration of the electrochemical hydrogen pump 100 and the first eliminator 300 is an example, and the configuration is not limited to this example.

As above, in the hydrogen system 200 of the present example, the electrochemical hydrogen pump 100 is a stacked product that includes a cell including a cathode CA, an electrolyte membrane 11, and an anode AN, and the first removal unit 300A of the first eliminator 300 and this stacked product are integrally stacked.

Consequently, the hydrogen system 200 of the present example can simplify the system configuration by stacking the hydrogen pump unit 100A and the first removal unit 300A. For example, in the hydrogen pump unit 100A and the first removal unit 300A, a high-pressure cathode gas flows. Accordingly, if the hydrogen pump unit and the first removal unit are separately provided, high-rigid end plates for fixing the hydrogen pump unit and the first removal unit, respectively, are necessary in many cases.

Accordingly, in the hydrogen system 200 of the present example, for example, since the end plates that are used for the hydrogen pump unit 100A and the first removal unit 300A can be shared as the anode end plate 24A and the cathode end plate 24C by integrally stacking the first removal unit 300A and the above-described stacked product, the system configuration is simplified.

Incidentally, as shown in FIGS. 6, 7, and 8, in the hydrogen system 200 of the present example, a pair of upper and lower first removal units 300A are stacked so as to sandwich the hydrogen pump unit 100A therebetween from the upper and lower sides. Consequently, the hydrogen system 200 of the present example can easily and properly suppress an increase in the contact resistance between members of the hydrogen pump unit 100A. The reason of this is as follows.

If a first removal unit is integrally stacked only on the upper or lower side of the hydrogen pump unit 100A, the pressure of the cathode gas compressed at the cathode CA of the hydrogen pump unit 100A directly acts on the end plate (the anode end plate 24A or the cathode end plate 24C) on the side where the first removal unit is not stacked. On this occasion, if the rigidity of the end plate is insufficient, there is a risk that the end plate on the side where the first removal unit is not stacked deforms so as to expand to the outside. Consequently, when the elastic deformation of the cathode gas diffusion layer cannot follow such deformation, a gap is generated between members of the hydrogen pump unit 100A, and the contact resistance between these members may increase.

In contrast, in the hydrogen system 200 of the present example, since a pair of upper and lower first removal units 300A are integrally stacked on the lower and upper sides, respectively, of the hydrogen pump unit 100A, the above inconvenience can be reduced. That is, as shown in FIG. 6, the cathode gas compressed at the cathode CA of the hydrogen pump unit 100A is supplied to the cathode gas flow paths 114 of the pair of upper and lower first removal units 300A through the first cathode gas pass-through path 54, the cathode gas pass-through manifold 50, and the second cathode gas pass-through path 55. Accordingly, the gas pressure in these cathode gas flow paths 114 becomes high to be almost equal to the gas pressure in the cathode CA of the hydrogen pump unit 100A. Consequently, the load to be applied to each member of the hydrogen pump unit 100A by the cathode gas in the cathode gas flow path 114 acts such that the deformation (deflection) of these members caused by the gas pressure in the cathode CA is depressed from the upper and lower sides.

Accordingly, in the hydrogen system 200 of the present example, since a gap is hardly generated between members of the hydrogen pump unit 100A, compared to when the first removal unit 300A is integrally stacked only on the upper or lower side of the hydrogen pump unit 100A, the increase in the contact resistance between these members can be easily and properly suppressed.

Incidentally, as shown in FIGS. 6, 7, and 8, in the hydrogen system 200 of the present example, the water-permeable membrane 115 is not energized. That is, no voltage is applied to the water-permeable membrane 115 by the voltage application device 102 because of the presence of the anode insulating plate 23A and the cathode insulating plate 23C. Here, when the water-permeable membrane 115 is a proton conductive electrolyte membrane 11, if electrodes including a material (for example, platinum) that accelerates electrochemical hydrogen oxidation reaction and hydrogen generation reaction are provided on both sides of the water-permeable membrane 115 and a current is passed between the electrodes on the water-permeable membrane 115, protons move in the water-permeable membrane 115 according to the current, and, for example, there is a risk of causing electrolysis of a low-pressure liquid (e.g., water) in the water-permeable membrane 115.

Accordingly, the hydrogen system 200 of the present example can reduce such a risk by the configuration such that the water-permeable membrane 115 is not energized.

Except for the above features, the hydrogen system 200 of the present example may be the same as the hydrogen system 200 according to any one of the First Embodiment and the First and Second Examples of the First Embodiment.

### Second Embodiment

### Apparatus Configuration

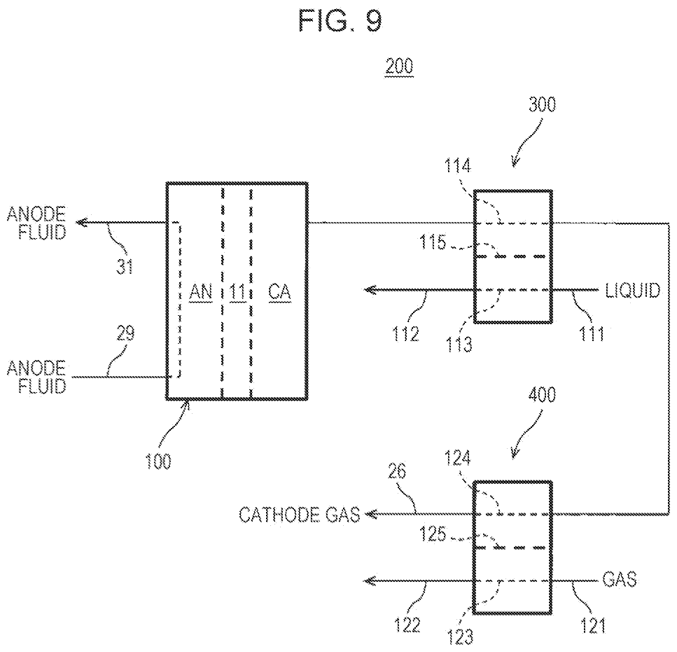

FIG. 9 is a diagram illustrating an example of the hydrogen system of a Second Embodiment.

In the example shown in FIG. 9, the hydrogen system 200 includes an electrochemical hydrogen pump 100, a first eliminator 300, and a second eliminator 400.

Here, the electrochemical hydrogen pump 100 and the first eliminator 300 are the same as those in the hydrogen system 200 of the First Embodiment, and the description thereof is omitted.

The second eliminator 400 is a device for flowing the cathode gas passed through the first eliminator 300 to one main surface of the water-permeable membrane 125 and flowing a gas of which the chemical potential of water vapor contained in the gas is lower than that of the cathode gas to the other main surface. Incidentally, examples of the gas include, but not limited to, air in a dry state.

The second eliminator 400 may have any configuration as long as it is a membrane-type eliminating device that can remove moisture contained in a cathode gas.

In the example shown in FIG. 9, the second eliminator 400 includes a flow path 124 (hereinafter, cathode gas flow path 124) through which the high-pressure cathode gas passed through the first eliminator 300 flows, a flow path 123 (hereinafter, gas flow path 123) through which a low-pressure gas flows, and a water-permeable membrane 125 provided between these flow paths 123 and 124. Incidentally, in the second eliminator 400, a cathode gas extraction path 26 for flowing the cathode gas in the cathode gas flow path 124 and a gas introduction path 121 and a gas extraction path 122 for flowing a gas in the gas flow path 123 are provided.

The water-permeable membrane 125 may have any configuration as long as it is a membrane that has low permeability for hydrogen (H₂) in a cathode gas and permeates moisture in the cathode gas. The water-permeable membrane 125 may be made of, for example, a membrane of a polymer having a sulfonate group as in the water-permeable membrane 115 of the first eliminator 300.

Incidentally, an example of the hydrogen system 200 of FIG. 9 in which an electrochemical hydrogen pump 100, a first eliminator 300, and a second eliminator 400 are integrally configured will be described in Example.

### Operation

An example of operation of the hydrogen system 200 of the Second Embodiment will now be described with reference to the drawings.

Incidentally, the following operation may be performed by, for example, reading out a control program from a memory circuit of a controller (not shown) by an arithmetic circuit of the controller. However, it is not indispensable to perform the following operation by a controller. An operator may perform a part of the operation. The operation of the hydrogen system 200 when a hydrogen-containing gas is used as the anode fluid will be described below.

First, a hydrogen-containing gas of a low pressure is supplied to the anode AN of the electrochemical hydrogen pump 100, and also the voltage of a voltage application device (not shown in FIG. 9) is applied to the electrochemical hydrogen pump 100. Consequently, in the electrochemical hydrogen pump 100, protons extracted from the hydrogen-containing gas that is supplied to the anode AN move to the cathode CA through the electrolyte membrane 11, and hydrogen compression operation for generating compressed hydrogen is performed.

Incidentally, since such hydrogen compression operation is the same as the operation of the electrochemical hydrogen pump 100 of the First Embodiment, the detailed description thereof is omitted.

Hydrogen generated at the cathode CA of the electrochemical hydrogen pump 100 is compressed at the cathode CA as a cathode gas containing water vapor. For example, the cathode gas can be compressed at the cathode CA by increasing the pressure drop of the cathode gas extraction path 26 by using a flow rate regulator (not shown). Incidentally, as the flow rate regulator, for example, a back pressure valve and a regulating valve provided in the cathode gas extraction path 26 can be exemplified.

Subsequently, the pressure drop of the flow rate regulator is decreased to discharge the cathode gas from the cathode CA of the electrochemical hydrogen pump 100 to the outside of the electrochemical hydrogen pump 100 through the cathode gas extraction path 26.

Consequently, in the first eliminator 300, the cathode gas to be discharged from the cathode CA of the electrochemical hydrogen pump 100 flows to one main surface of the water-permeable membrane 115. Accordingly, in the first eliminator 300, the operation of removing moisture contained in the cathode gas is performed by flowing a liquid at a pressure lower than that of the cathode gas to the other main surface of the water-permeable membrane 115. Incidentally, on this occasion, the temperature of the liquid flowing into the first eliminator 300 may be lower than the temperature of the cathode gas flowing into the first eliminator 300.

In the second eliminator 400, the cathode gas passed through the first eliminator 300 flows to one main surface of the water-permeable membrane 125. Accordingly, in the second eliminator 400, operation for removing the moisture in the cathode gas is performed by flowing a gas of which the chemical potential of water vapor contained in the gas is lower than that of the cathode gas to the other main surface of the water-permeable membrane 125.

From the above, the hydrogen system 200 of the present embodiment can remove moisture contained in the cathode gas to be discharged from the cathode CA of the electrochemical hydrogen pump 100 more efficiently than before. Incidentally, the function and effect of the removal of moisture contained in the cathode gas by the first eliminator 300 are the same as those by the hydrogen system 200 of the First Embodiment, and the description thereof is omitted.

Here, in the first eliminator 300, since a liquid (for example, water) flows through the liquid flow path 113, as understood from the data on the chemical potential of a relative humidity of 100% shown in FIG. 3, there is a natural limit to the reduction of relative humidity of the cathode gas flowing through the cathode gas flow path 114. That is, it may be difficult to remove moisture in the cathode gas using only the first eliminator 300 until the amount of moisture in the cathode gas is decreased to a desired low concentration.

Accordingly, the hydrogen system 200 of the present example flows a gas of which the chemical potential of water vapor contained in the gas is lower than that of the cathode gas through the second eliminator 400 to the other main surface of the water-permeable membrane 125. Consequently, the hydrogen system 200 of the present embodiment can decrease the amount of moisture in the cathode gas to a low concentration compared to the case of removing moisture in the cathode gas with only the first eliminator 300.

Except for the above features, the hydrogen system 200 of the present embodiment may be the same as the hydrogen system 200 according to any one of the First Embodiment and the First to Third Examples of the First Embodiment. For example, the hydrogen system 200 of the present embodiment may include a recycle flow path 140, a supply path 130, and a hydrogen source 700 (see FIG. 5) as in the hydrogen system 200 of the First Example of the First Embodiment, in addition to the electrochemical hydrogen pump 100, the first eliminator 300, and the second eliminator 400. In addition, in the hydrogen system 200 of the present embodiment, for example, a first porous structure may be provided in the gas flow path 123 in the second eliminator 400, and a second porous structure may be provided in the cathode gas flow path 124 in the second eliminator 400 so as to be in contact with the water-permeable membrane 125, as in the hydrogen system 200 of the Second Example of the First Embodiment.

### EXAMPLE

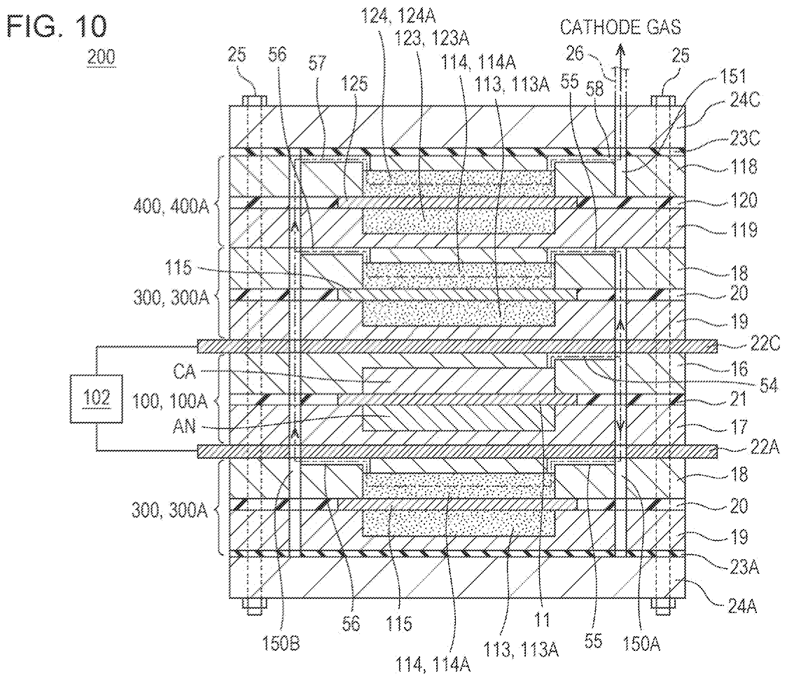

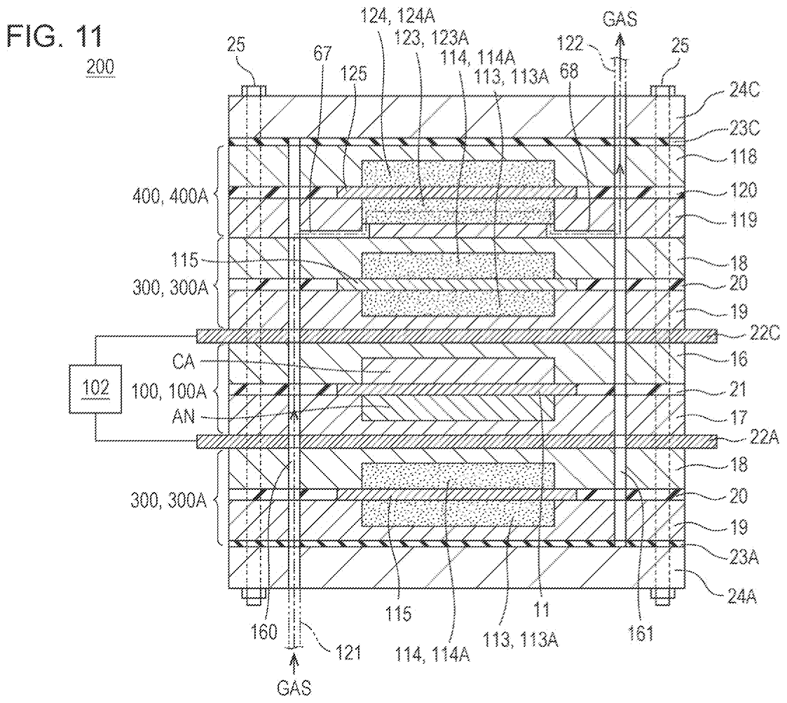

FIGS. 10 and 11 are diagrams illustrating an example of the hydrogen system of an Example of the Second Embodiment. In the hydrogen system 200 of the present example, an electrochemical hydrogen pump 100, first eliminators 300, and a second eliminator 400 are integrally configured.

Incidentally, FIG. 10 shows a vertical cross section including a straight line passing through the center of the hydrogen system 200, the center of a first cathode gas pass-through manifold 150A, and the center of a second cathode gas pass-through manifold 150B in a planar view. FIG. 11 shows a vertical cross section including a straight line passing through the center or the hydrogen system 200, the center of a gas introduction manifold 160, and the center of a gas extraction manifold 161 in a planar view.

Here, illustration of a vertical cross section including a straight line passing through the center of the hydrogen system 200, the center of the anode gas introduction manifold, and the center of the anode gas extraction manifold in a planar view can be easily understood by considering the content illustrated in FIG. 7 described in the Third Example of the First Embodiment, and the illustration thereof is omitted. That is, although in the hydrogen system 200 of FIG. 7, the anode gas extraction manifold 41 is composed of a series of communication holes provided at appropriate positions of each member of the hydrogen pump unit 100A and the first removal unit 300A, the anode feed plate 22A, the cathode feed plate 22C, the cathode insulating plate 23C, and the cathode end plate 24C, in the hydrogen system 200 of the present example, the anode gas extraction manifold is composed of a series of communication holes provided at appropriate positions of each member of the second eliminator 400 together with the communication holes of the above-mentioned members.

Similarly, illustration of a vertical cross section including a straight line passing through the center of the hydrogen system 200, the center of the liquid introduction manifold, and the center of the liquid extraction manifold in a planar view can be easily understood by considering the content illustrated in FIG. 8 described in the Third Example of the First Embodiment, and the illustration thereof is omitted. That is, although in the hydrogen system 200 of FIG. 8, the liquid extraction manifold 61 is composed of a series of communication holes provided at appropriate positions of each member of the hydrogen pump unit 100A and the first removal unit 300A, the anode feed plate 22A, the cathode feed plate 22C, the cathode insulating plate 23C, and the cathode end plate 24C, in the hydrogen system 200 of the present example, the liquid extraction manifold is composed of a series of communication holes provided at appropriate positions of each member of the second eliminator 400 together with the communication holes of above-mentioned members.

Furthermore, the configuration of the electrochemical hydrogen pump 100 and the configuration of the first eliminator 300 of the hydrogen system 200 of the present example are the same as those of the hydrogen system 200 of the Third Example of the First Embodiment, and the description thereof is omitted. In addition, the configuration of fastening the electrochemical hydrogen pump 100, the first eliminator 300, and the second eliminator 400, the configuration of the flow path for the hydrogen-containing gas in the electrochemical hydrogen pump 100, and the configuration of the flow path for the cooling water in the first eliminator 300 can be easily understood by considering the content described in the Third Example of the First Embodiment, and the description thereof is omitted.

### Configuration of Second Eliminator

An example of the configuration of the second eliminator 400 will now be described with reference to the drawings.

As shown in FIGS. 10 and 11, the hydrogen system 200 includes a second removal unit 400A of the second eliminator 400.

Incidentally, in the example shown in FIGS. 10 and 11, although one second removal unit 400A is shown in the second eliminator 400, the number of the second removal unit 400A is not limited to this example. In addition, the second removal unit 400A is provided between the cathode insulating plate 23C and the upper first removal unit 300A, but the arrangement of the second removal unit 400A is not limited to this example. The second removal unit may be provided, for example, between the anode insulating plate 23A and the lower first removal unit 300A.

The second removal unit 400A includes a water-permeable membrane 125, a first porous structure 123A, a second porous structure 124A, a separator 118, a separator 119, and an insulator 120.

The water-permeable membrane 125 may have any configuration as long as it is a membrane that has low permeability for hydrogen (H₂) in a cathode gas and permeates moisture in the cathode gas, as described above. Incidentally, as such a water-permeable membrane 125, for example, a proton conductive polymer membrane made of a material similar to that of the electrolyte membrane 11 and allowing protons (H⁺) to pass therethrough can be used. That is, examples of the water-permeable membrane 125 include, but not limited to, a fluorine-based polymer membrane and a hydrocarbon-based polymer membrane that can be used as a proton conductive polymer membrane.

The first porous structure 123A is provided in the gas flow path 123 so as to be in contact with the water-permeable membrane 125. The first porous structure 123A desirably has high rigidity that can suppress the displacement and deformation of the water-permeable membrane 125 occurring due to a differential pressure between the cathode gas flow path 124 (high pressure) and the gas flow path 123 (low pressure) of the second eliminator 400. Incidentally, the base material of such a first porous structure 123A may be, for example, the same metal material as that of the anode gas diffusion layer.

The second porous structure 124A is provided in the cathode gas flow path 124 so as to be in contact with the water-permeable membrane 125. The second porous structure 124A desirably has elasticity so as to appropriately follow the displacement and deformation of the water-permeable membrane 125 occurring due to a differential pressure between the cathode gas flow path 124 (high pressure) and the gas flow path 123 (low pressure) of the second eliminator 400. Incidentally, the base material of such a second porous structure 124A may be, for example, the same metal material as that of the cathode gas diffusion layer.

The separator 118 is a member provided on the second porous structure 124A. The separator 119 is a member provided on the first porous structure 123A.

The separator 118 and the separator 119 are each provided with a recess at the respective center. The second porous structure 124A and the first porous structure 123A are respectively accommodated in these recesses. Incidentally, in the present example, the regions partitioned by the respective recesses of the separator 118 or the separator 119 and the water-permeable membrane 125 constitute the cathode gas flow path 124 and the gas flow path 123, respectively, of the second eliminator 400.

In addition, an annular and tabular insulator 120 that is provided so as to surround the circumference of the MEA in a planar view is sandwiched between the separator 118 and the separator 119.

The second removal unit 400A may thus have a cell structure as in the hydrogen pump unit 100A.

### Flow Path Configuration for Cathode Gas

An example of the configuration of the flow path for the cathode gas in the electrochemical hydrogen pump 100, the first eliminator 300, and the second eliminator 400 will now be described with reference to FIG. 10. Incidentally, in FIG. 10, a schematic diagram of the flow of a cathode gas is shown by an arrow of a thin dash-dot-dash line.

As shown in FIG. 10, the hydrogen system 200 includes a first cathode gas pass-through manifold 150A, a second cathode gas pass-through manifold 150B, and a cathode gas extraction manifold 151.

The first cathode gas pass-through manifold 150A is composed of a series of communication holes provided at appropriate positions of each member of the hydrogen pump unit 100A and the first removal unit 300A, the anode feed plate 22A, and the cathode feed plate 22C. The first cathode gas pass-through manifold 150A communicates with the cathode gas diffusion layer of the cathode CA through a first cathode gas pass-through path 54 provided in the cathode separator 16 and also communicates with the cathode gas flow path 114 through a second cathode gas pass-through path 55 provided in the separator 18.

The second cathode gas pass-through manifold 150B is composed of a series of communication holes provided at appropriate positions of each member of the hydrogen pump unit 100A, the first removal unit 300A, and the second removal unit 400A, the anode feed plate 22A, and the cathode feed plate 22C. The second cathode gas pass-through manifold 150B communicates with the cathode gas flow path 114 through a third cathode gas pass-through path 56 provided in the separator 18 and also communicates with the cathode gas flow path 124 through a fourth cathode gas pass-through path 57 provided in the separator 118.

The cathode gas extraction manifold 151 is composed of a series of communication holes provided at appropriate positions of the separator 118 of the hydrogen pump unit 100A, the cathode insulating plate 23C, and the cathode end plate 24C. A cathode gas extraction path 26 (see FIG. 10) is connected to the communication hole of the cathode end plate 24C. Consequently, the cathode gas extraction path 26 and the cathode gas extraction manifold 151 are communicated with each other. The cathode gas extraction path 26 may be configure of a pipe for flowing the cathode gas. The cathode gas extraction manifold 151 then communicates with the cathode gas flow path 124 through a fifth cathode gas pass-through path 58 provided in the separator 118.

Incidentally, in the example shown in FIG. 10, the first cathode gas pass-through manifold 150A and the cathode gas extraction manifold 151 are provided with the separator 119 and the insulator 120 therebetween such that the center of the first cathode gas pass-through manifold 150A and the center of the cathode gas extraction manifold 151 pass through the same straight line, but the arrangement of these manifolds is not limited to this example.

Due to the configuration above, the high-pressure cathode gas compressed at the cathode CA of the electrochemical hydrogen pump 100 flows through the first cathode gas pass-through path 54, the first cathode gas pass-through manifold 150A, the second cathode gas pass-through path 55, the cathode gas flow path 114, the third cathode gas pass-through path 56, and the second cathode gas pass-through manifold 150B in this order as shown by the arrow of a dash-dot-dash line in FIG. 10. Subsequently, the cathode gas flows through the fourth cathode gas pass-through path 57, the cathode gas flow path 124, the fifth cathode gas pass-through path 58, and the cathode gas extraction manifold 151 and is then discharged to the outside of the hydrogen system 200 through the cathode gas extraction path 26. On this occasion, when the cathode gas passes through the cathode gas flow path 114 of the first removal unit 300A and the cathode gas flow path 124 of the second removal unit 400A in this order, the moisture in the cathode gas is removed in the first removal unit 300A and the second removal unit 400A.

Incidentally, annular sealing members (not shown) are provided at appropriate positions between members in a planar view so as to surround the first cathode gas pass-through manifold 150A, the second cathode gas pass-through manifold 150B, and the cathode gas extraction manifold 151, and the first cathode gas pass-through manifold 150A, the second cathode gas pass-through manifold 150B, and the cathode gas extraction manifold 151 are appropriately sealed by the sealing members.

### Flow Path Configuration of Gas

An example of the configuration of the flow path for a gas (for example, dry air) to be supplied to the gas flow path 123 of the second removal unit 400A will now be described with reference to FIG. 11. Incidentally, in FIG. 11, a schematic diagram of the flow of a gas is shown by an arrow of a thin dash-dot-dash line.

As shown in FIG. 11, the hydrogen system 200 includes a gas introduction manifold 160 and a gas extraction manifold 161.

The gas introduction manifold 160 is composed of a series of communication holes provided at appropriate positions of each member of the hydrogen pump unit 100A, the first removal unit 300A, and the second removal unit 400A, the anode feed plate 22A, the cathode feed plate 22C, the anode insulating plate 23A, and the anode end plate 24A. A gas introduction path 121 (see FIG. 9) is communicated with the communication hole of the anode end plate 24A. Consequently, the gas introduction path 121 and the gas introduction manifold 160 are communicated with each other. The gas introduction path 121 may be configured of a pipe through which the gas to be supplied to the gas flow path 123 flows. The gas introduction manifold 160 then communicates with the gas flow path 123 through a first gas pass-through path 67 provided in the separator 119.

The gas extraction manifold 161 is composed of a series of communication holes provided at appropriate positions of each member of the hydrogen pump unit 100A, the first removal unit 300A, and the second removal unit 400A, the anode feed plate 22A, the cathode feed plate 22C, the cathode insulating plate 23C, and the cathode end plate 24C. A gas extraction path 122 (see FIG. 9) is connected to the communication hole of the cathode end plate 24C. Consequently, the gas extraction path 122 and the gas extraction manifold 161 are communicated with each other. The gas extraction path 122 may be configured of a pipe through which the gas to be discharged from the gas flow path 123 flows. The gas extraction manifold 161 then communicates with the gas flow path 123 through a second gas pass-through path 68 provided in the separator 119.

Due to the configuration above, the gas from the gas introduction path 121 flows through the gas introduction manifold 160, the first gas pass-through path 67, the gas flow path 123, the second gas pass-through path 68, and the gas extraction manifold 161 in this order as shown by the arrow of a dash-dot-dash line in FIG. 11. Subsequently, the gas is discharged to the outside of the second removal unit 400A through the gas extraction path 122.

Incidentally, annular sealing members (not shown) are provided at appropriate positions between members in a planar view so as to surround the gas introduction manifold 160 and the gas extraction manifold 161, and the gas introduction manifold 160 and the gas extraction manifold 161 are appropriately sealed by the sealing members.

Incidentally, the above integrated configuration of the electrochemical hydrogen pump 100, the first eliminator 300, and the second eliminator 400 is an example, and the configuration is not limited to this example.

As above, in the hydrogen system 200 of the present example, the electrochemical hydrogen pump 100 is a stacked product that includes a cell including a cathode CA, an electrolyte membrane 11, and an anode AN, and the first removal unit 300A of the first eliminator 300, the second removal unit 400A of the second eliminator 400, and this stacked product are integrally stacked.

Consequently, the hydrogen system 200 of the present example can simplify the system configuration by stacking the hydrogen pump unit 100A, the first removal unit 300A, and the second removal unit 400A. For example, in the hydrogen pump unit 100A and the second removal unit 400A, a high-pressure cathode gas flows. Accordingly, if the hydrogen pump unit and the second removal unit are separately provided, high-rigid end plates for fixing the hydrogen pump unit and the second removal unit, respectively, are necessary in many cases.

Accordingly, in the hydrogen system 200 of the present example, for example, since the end plates that are used for the hydrogen pump unit 100A and the second removal unit 400A can be shared as the anode end plate 24A and the cathode end plate 24C by integrally stacking the second removal unit 400A and the above-described stacked product, the system configuration is simplified.

Incidentally, as shown in FIGS. 10 and 11, in the hydrogen system 200 of the present example, the water-permeable membrane 115 and the water-permeable membrane 125 are not energized. That is, no voltage is applied by the voltage application device 102 to the water-permeable membrane 115 and the water-permeable membrane 125 because of the presence of the anode insulating plate 23A and the cathode insulating plate 23C. The reason of this configuration is the same as that described in the Third Example of the First Embodiment.

Except for the above features, the hydrogen system 200 of the present example may be the same as the hydrogen system 200 according to any one of the First Embodiment, the First to Third Examples of the First Embodiment, and the Second Embodiment.

### Third Embodiment

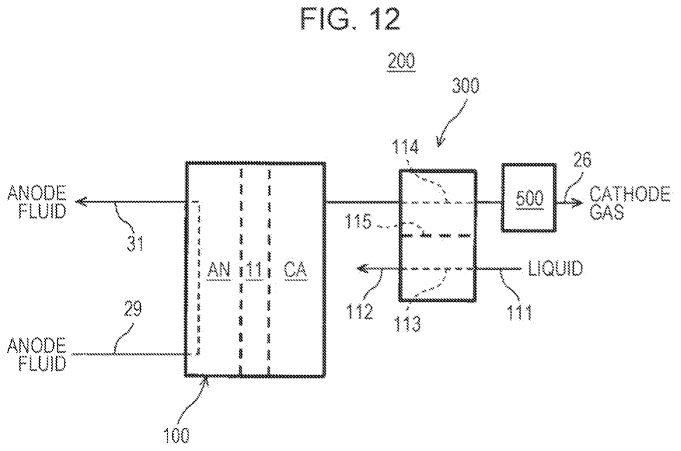

FIG. 12 is a diagram illustrating an example of the hydrogen system of a Third Embodiment.

In the example shown in FIG. 12, the hydrogen system 200 includes an electrochemical hydrogen pump 100, a first eliminator 300, and a third eliminator 500.

Here, the electrochemical hydrogen pump 100 and the first eliminator 300 are the same as those in the hydrogen system 200 of the First Embodiment, and the description thereof is omitted.

The third eliminator 500 is a device including an adsorbent removing moisture in the cathode gas passed through the first eliminator 300. The third eliminator 500 may have any configuration as long as it is such an eliminator using an adsorbent. The adsorbent of the third eliminator 500 may be made of any material as long as the material adsorbs and removes moisture, such as water vapor, in a cathode gas. Examples of the material of the adsorbent include porous materials such as zeolite and silica gel. Incidentally, although adsorption of moisture is performed when the adsorbent is dry, since the moisture adsorbing performance of the adsorbent decreases by adsorbing moisture in the course of time, it is necessary to displace or regenerate the adsorbent.

As described above, it may be difficult to remove moisture in a cathode gas using only the first eliminator 300 until the amount of moisture in the cathode gas is decreased to a desired low concentration (for example, about 5 ppm).

Accordingly, the hydrogen system 200 of the present embodiment easily remove moisture in the cathode gas passed through the first eliminator 300 using the adsorbent of the third eliminator 500.

In addition, in the hydrogen system 200 of the present embodiment, the adsorbent of the third eliminator 500 may adsorb and remove only the moisture, which could not be removed by the first eliminator 300, contained in the cathode gas. Consequently, the hydrogen system 200 of the present embodiment can decrease the amount of moisture adsorbing to the adsorbent per unit time, compared to the case of not removing moisture in the cathode gas by the first eliminator 300. Consequently, even if the filling amount of the adsorbent in the third eliminator 500 is decreased, since the moisture adsorbing performance of the adsorbent of the third eliminator 500 can be appropriately maintained for a desired period, it is possible to reduce the size and cost of the third eliminator 500.

In addition, in the hydrogen system 200 of the present embodiment, a hydrogen storage unit (not shown) for storing the cathode gas (hydrogen) from which moisture is removed by the third eliminator 500 may be provided. Examples of the hydrogen storage unit include a hydrogen tank. Incidentally, the cathode gas (hydrogen) in a dry state stored in the hydrogen storage unit is supplied to a hydrogen consumer in a timely manner. Examples of the hydrogen consumer include a fuel cell.

Except for the above features, the hydrogen system 200 of the present embodiment may be the same as the hydrogen system 200 according to any one of the First Embodiment, the First to Third Examples of the First Embodiment, the Second Embodiment, and the Example of the Second Embodiment. For example, the hydrogen system 200 of the present embodiment may include a recycle flow path 140, a supply path 130, and a hydrogen source 700 (see FIG. 5) as in the hydrogen system 200 of the First Example of the First Embodiment, in addition to the electrochemical hydrogen pump 100, the first eliminator 300, and the third eliminator 500. In addition, in the hydrogen system 200 of the present embodiment, for example, the second eliminator 400 (see FIG. 9) described in the Second Embodiment may be provided between the first eliminator 300 and the third eliminator 500.

### Fourth Embodiment

The hydrogen system 200 of a Fourth Embodiment is the same as the hydrogen system 200 of the First Embodiment, except for the configuration of the first eliminator 301 described below.

The first eliminator 301 includes a water-permeable membrane 115, a flow path (hereinafter, cathode gas flow path 114) provided on one main surface of the water-permeable membrane 115 and through which the cathode gas to be discharged from the cathode CA of the electrochemical hydrogen pump 100 flows, and an accommodation portion provided on the other main surface of the water-permeable membrane 115 and filled with a liquid at a pressure lower than that of the cathode gas, and the first eliminator 301 is a device for removing moisture contained in the cathode gas. Incidentally, the moisture in the cathode gas includes liquid water contained in the cathode gas. The moisture to be removed by the first eliminator 301 includes, for example, condensed water condensed from the cathode gas. This condensed water is generated in the flow path from the cathode CA of the electrochemical hydrogen pump 100 to the first eliminator 301 of the cathode gas extraction path 26 or in the cathode gas flow path 114 in the first eliminator 301.

The first eliminator 301 may have any configuration as long as it is a membrane-type eliminating device that can remove moisture contained in a cathode gas.

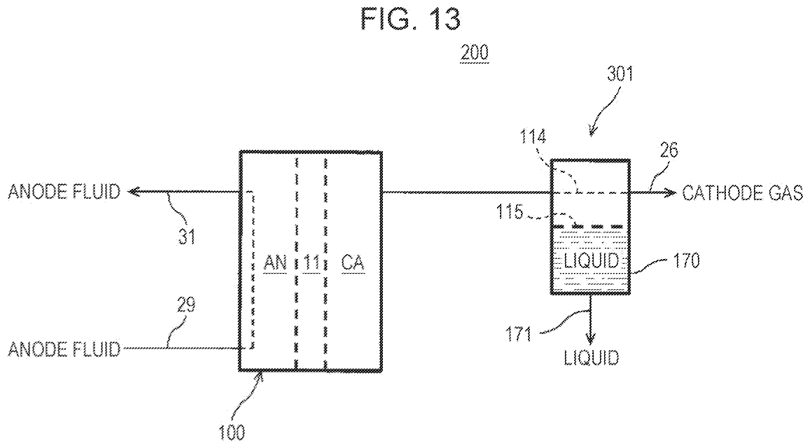

For example, as shown in FIG. 13, the first eliminator 301 may include a cathode gas flow path 114, a container 170, a water-permeable membrane 115 provided between the cathode gas flow path 114 and the container 170, and a discharge path 171 discharging the liquid in the container 170. That is, in this case, the container 170 corresponds to the above-described accommodation portion. The discharge path 171 then extends so as to communicate between the outside and the inside of the container.

Subsequently, an example of operation of the hydrogen system 200 of the present embodiment will now be described with reference to the drawings.

Incidentally, the following operation may be performed by, for example, reading out a control program from a memory circuit of a controller (not shown) by an arithmetic circuit of the controller. However, it is not indispensable to perform the following operation by a controller. An operator may perform a part of the operation.

First, a hydrogen-containing gas of a low pressure is supplied to the anode AN of the electrochemical hydrogen pump 100, and also the voltage of a voltage application device (not shown in FIG. 13) is applied to the electrochemical hydrogen pump 100. Consequently, in the electrochemical hydrogen pump 100, protons extracted from the hydrogen-containing gas that is supplied to the anode AN move to the cathode CA through the electrolyte membrane 11, and a step of generating compressed hydrogen (hydrogen compression operation) is performed. Incidentally, such hydrogen compression operation is the same as that in the First Embodiment, and detailed description thereof is omitted.

Subsequently, the pressure drop of the flow rate regulator provided in the cathode gas extraction path 26 is decreased to discharge the cathode gas from the cathode CA of the electrochemical hydrogen pump 100 to the outside of the electrochemical hydrogen pump 100 through the cathode gas extraction path 26.

Consequently, in the first eliminator 301, a step of moving moisture from the cathode gas containing compressed hydrogen to a low-pressure liquid in the container 170 through the water-permeable membrane 115 is performed. Specifically, in the first eliminator 301, the cathode gas to be discharged from the cathode CA of the electrochemical hydrogen pump 100 flows to one main surface of the water-permeable membrane 115. Accordingly, in the first eliminator 301, operation for removing the moisture contained in the cathode gas is performed by filling the container 170 provided on the other main surface of the water-permeable membrane 115 with a liquid at a pressure lower than that of the cathode gas. On this occasion, the moisture includes liquid water contained in the cathode gas. This moisture includes, for example, condensed water condensed from the cathode gas. This condensed water is generated in the flow path from the cathode CA of the electrochemical hydrogen pump 100 to the first eliminator 301 of the cathode gas extraction path 26 or in the cathode gas flow path 114 in the first eliminator 301. In addition, the temperature of the liquid may be lower than the temperature of the cathode gas flowing into the first eliminator 301. In addition, in the discharge path 171, a step of discharging the liquid in the container 170 may be performed.

Incidentally, during the operation of the hydrogen system 200, the container 170 need not be filled with a liquid and may be in an empty state. For example, condensed water moves from the cathode gas to the inside of the container 170 through the water-permeable membrane 115 by operating the hydrogen system 200. Consequently, the container 170 can be fully filled with water.

From the above, the hydrogen system 200 and the method of operating the hydrogen system 200 of the present embodiment can remove moisture contained in the cathode gas to be discharged from the cathode CA of the electrochemical hydrogen pump 100 more efficiently than before.

Incidentally, the functions and effects by the hydrogen system 200 and the method of operating the hydrogen system 200 of the present embodiment are the same as those by the hydrogen system 200 and the method of operating the hydrogen system 200 of the First Embodiment, and the detailed description thereof is omitted.

Except for the above features, the hydrogen system 200 and the method of operating the hydrogen system 200 of the present embodiment may be the same as those of any one of the First Embodiment, the First to Third Examples of the First Embodiment, the Second Embodiment, the Example of the Second Embodiment, and the Third Embodiment. For example, in the hydrogen system 200 of the present embodiment, the second eliminator 400 (see FIG. 9) described in the Second Embodiment and the third eliminator 500 (see FIG. 12) described in the Third Embodiment may be provided.

### EXAMPLE

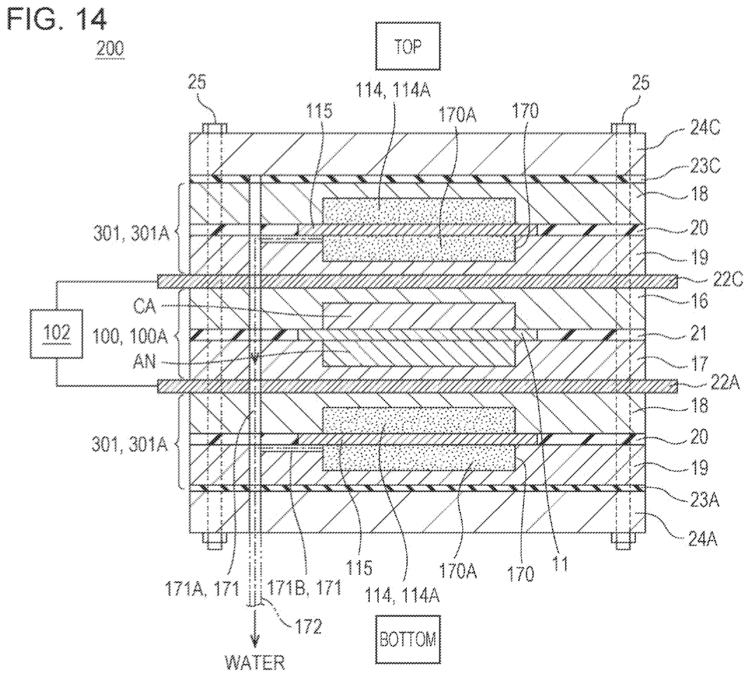

FIG. 14 is a diagram illustrating an example of the hydrogen system of an Example of the Fourth Embodiment. In the hydrogen system 200 of the present example, an electrochemical hydrogen pump 100 and a first eliminator 301 are integrally configured.

Incidentally, FIG. 14 shows a vertical cross section including a straight line passing through the center of the hydrogen system 200 and the center of the water discharge manifold 171A in a planar view. In addition, in FIG. 14, “top” and “bottom” are taken as shown in the drawing, and gravity acts from the top to the bottom.

Here, illustration of a vertical cross section including a straight line passing through the center of the hydrogen system 200, the center of the cathode gas pass-through manifold 50, and the center of the cathode gas extraction manifold 51 in a planar view can be easily understood by considering the content illustrated in FIG. 6 described in the Third Example of the First Embodiment, and the illustration thereof is omitted.

Similarly, illustration of a vertical cross section including a straight line passing through the center of the hydrogen system 200, the center of the anode gas introduction manifold 40, and the center of the anode gas extraction manifold 41 in a planar view can be easily understood by considering the content illustrated in FIG. 7 described in the Third Example of the First Embodiment, and the illustration thereof is omitted.

Furthermore, the configuration of the electrochemical hydrogen pump 100 of the hydrogen system 200 of the present example is the same as that of the hydrogen system 200 of the Third Example of the First Embodiment, and the description thereof is omitted. In addition, the configuration of fastening the electrochemical hydrogen pump 100 and the first eliminator 301 and the configuration of the flow path for the cathode gas and the hydrogen-containing gas in the electrochemical hydrogen pump 100 can be easily understood by considering the content described in the Third Example of the First Embodiment, and the description thereof is omitted.

### Configuration of First Eliminator

An example of the configuration of the first eliminator 301 will now be described with reference to the drawings.

As shown in FIG. 14, the hydrogen system 200 includes first removal units 301A of a pair of upper and lower first eliminators 301 provided so as to sandwich the hydrogen pump unit 100A therebetween through the anode feed plate 22A and the cathode feed plate 22C, respectively.

Incidentally, in the example shown in FIG. 14, although one first removal unit 301A is shown in each of the first eliminators 301, the number of the first removal unit 301A is not limited to this example. In addition, the first removal units 301A provided in each of the pair of upper and lower first eliminators 301 have the same configuration.

The first removal unit 301A includes a water-permeable membrane 115, a first porous structure 170A, a second porous structure 114A, a separator 18, a separator 19, and an insulator 20.

Here, the water-permeable membrane 115, the second porous structure 114A, the separator 18, and the insulator 20 are the same as those in the Third Example of the First Embodiment, and the description thereof is omitted.

In the hydrogen system 200 of the present example, the region (space) partitioned by the recess of the separator 19 and the water-permeable membrane 115 corresponds to the inside of the container 170. In this region, the first porous structure 170A is provided. Incidentally, since the configuration of the first porous structure 170A is the same as that of the first porous structure 113A described in the Third Example of the First Embodiment, the description thereof is omitted.

The above configuration of the first eliminator 301 is an example, and the configuration is not limited to this example. For example, the porous structure need not be provided in the region partitioned by the recess of the separator 19 and the water-permeable membrane 115.

### Flow Path Configuration of Discharge Path

An example of the flow path configuration of the discharge path 171 (water discharge path) when the liquid that is discharged from the container 170 of the first removal unit 301A is water will now be describe with reference to FIG. 14. Incidentally, in FIG. 14, a schematic diagram of the flow of water is shown by an arrow of a thin dash-dot-dash line.

As shown in FIG. 14, the hydrogen system 200 includes a water discharge manifold 171A.

The water discharge manifold 171A is composed of a series of communication holes provided at appropriate positions of each member of the hydrogen pump unit 100A and the first removal unit 301A, the anode feed plate 22A, the cathode feed plate 22C, the anode insulating plate 23A, and the anode end plate 24A. A water discharge path 172 is connected to the communication hole of the anode end plate 24A. Consequently, the water discharge path 172 and the water discharge manifold 171A communicate with each other. The water discharge path 172 may be configured of a pipe through which the water discharged from the container 170 flows. The water discharge manifold 171A then communicates with the inside of the container 170 through a water pass-through path 171B provided in the separator 19. Such a water pass-through path 171B may be configured of a communication groove provided in the main surface of the separator 19 being in contact with the other main surface side of the water-permeable membrane 115.

Incidentally, an annular sealing member (not shown) is provided at an appropriate position between members in a planar view so as to surround the water discharge manifold 171A, and the water discharge manifold 171A is appropriately sealed by the sealing member.

Due to the configuration above, the water in the container 170 flows through the water pass-through path 171B and the water discharge manifold 171A in this order as shown by the arrow of a dash-dot-dash line in FIG. 14. Subsequently, the water is discharged to the outside of the hydrogen system 200 through the water discharge path 172. For example, when the operation of the hydrogen system 200 is started, condensed water condensed from water vapor in the cathode gas moves to the inside of the container 170 through the water-permeable membrane 115. Consequently, the container 170 is fully filled with water, and the water in the container 170 is thereby sent to the water discharge manifold 171A through the water pass-through path 171B. Consequently, this water flows downward in the water discharge manifold 171A due to the action of gravity and then moves to the water discharge path 172. Thus, in the present example, the water discharge manifold 171A and the water pass-through path 171B constitute the discharge path 171 that discharges a liquid (water) in the container 170.

Incidentally, the above integrated configuration of the electrochemical hydrogen pump 100 and the first eliminator 301 is an example, and the configuration is not limited to this example.

As above, in the hydrogen system 200 of the present example, the electrochemical hydrogen pump 100 is a stacked product that includes a cell including a cathode CA, an electrolyte membrane 11, and an anode AN, and the first removal unit 301A of the first eliminator 301 and this stacked product are integrally stacked. Incidentally, the details of the function and effect by the hydrogen system 200 of the present example are the same as those by the hydrogen system 200 of the Third Example of the First Embodiment, and the description thereof is omitted.

Except for the above features, the hydrogen system 200 of the present example may be the same as the hydrogen system 200 according to any one of the First Embodiment, the First to Third Examples of the First Embodiment, the Second Embodiment, the Example of the Second Embodiment, the Third Embodiment, and the Fourth Embodiment.

The First Embodiment, the First to Third Examples of the First Embodiment, the Second Embodiment, the Example of the Second Embodiment, the Third Embodiment, the Fourth Embodiment, and the Example of the Fourth Embodiment may be combined with each other as long as they do not exclude each other.

In addition, many modifications and other embodiments of the present disclosure will be apparent to those skilled in the art from the above description. Accordingly, the above description should be construed as exemplary only and is provided for the purpose of teaching those skilled in the art the best mode of carrying out the present disclosure. The operation condition, composition, structure, and/or function can be changed substantially without departing from the spirit of the present disclosure. For example, the hydrogen system 200 may include another compressor, such as water electrolysis apparatus.

One aspect of the present disclosure can be used in, for example, a hydrogen system and a method of operating a hydrogen system that can remove moisture contained in a cathode gas to be discharged from a cathode of a compressor more efficiently than before.

What is claimed is:

1. A hydrogen system comprising:
a compressor in which protons extracted from an anode fluid supplied to an anode move to a cathode through an electrolyte membrane and compressed hydrogen is generated; and
a first eliminator including:
a water-permeable membrane;
a cathode gas flow path through which a cathode gas discharged from the cathode of the compressor flows, the cathode gas flow path being provided on one main surface of the water-permeable membrane; and
an accommodation portion provided on the other main surface of the water-permeable membrane and filled with a liquid at a pressure lower than that of the cathode gas,
the first eliminator removing moisture contained in the cathode gas.

2. The hydrogen system according to claim 1, comprising:
a discharge path discharging the liquid in the accommodation portion to the first eliminator.

3. The hydrogen system according to claim 1, wherein
the accommodation portion is a flow path through which the liquid flows.

4. The hydrogen system according to claim 1, wherein
a temperature of the liquid is lower than the temperature of the cathode gas flowing into the first eliminator.

5. The hydrogen system according to claim 1, wherein
the liquid includes water.

6. The hydrogen system according to claim 1, comprising:
a recycle flow path for supplying the liquid discharged from the first eliminator to the first eliminator again.

7. The hydrogen system according to claim 1, wherein
the liquid includes water;
the anode fluid is a hydrogen-containing gas; and
the system comprises a supply path supplying the liquid discharged from the first eliminator to the hydrogen-containing gas to be supplied to the anode.

8. The hydrogen system according to claim 1, wherein
the water-permeable membrane is a membrane of a polymer having a sulfonate group.

9. The hydrogen system according to claim 1, wherein
the water-permeable membrane is not energized.

10. The hydrogen system according to claim 3, comprising:
a first porous structure provided in the flow path through which the liquid in the first eliminator flows.

11. The hydrogen system according to claim 1, comprising:
a second porous structure provided in the cathode gas flow path so as to be in contact with the water-permeable membrane.

12. The hydrogen system according to claim 1, wherein
the compressor is a stacked product that includes a cell including the cathode, the electrolyte membrane, and the anode; and
the first eliminator and the stacked product are integrally stacked.

13. The hydrogen system according to claim 1, comprising
a second eliminator, wherein the cathode gas passed through the first eliminator flows over one main surface of a water-permeable membrane in the second eliminator and a gas of which the chemical potential of water vapor contained in the gas is lower than that of the cathode gas flows over to the other main surface in the second eliminator.

14. The hydrogen system according to claim 1, comprising
a third eliminator including an adsorbent that removes moisture in the cathode gas passed through the first eliminator.

15. A method of operating a hydrogen system comprising:
moving protons extracted from an anode fluid to be supplied to an anode to a cathode through an electrolyte membrane and generating compressed hydrogen; and
moving moisture from a cathode gas containing the compressed hydrogen to a low-pressure liquid filling an accommodation portion through a water-permeable membrane.

16. The method of operating a hydrogen system according to claim 15, comprising:
discharging the liquid in the accommodation portion.

17. The method of operating a hydrogen system according to claim 15, wherein
the accommodation portion is a flow path through which the liquid flows.

18. The method of operating a hydrogen system according to claim 15, wherein
a temperature of the liquid is lower than the temperature of the cathode gas.

19. The method of operating a hydrogen system according to claim 15, wherein
the liquid includes water.
